(19) United States
(12) Patent Application Publication
(10) Pub. No.: US 2022/0330501 A1
(43) Pub. Date: Oct. 20, 2022

(54) PLANT APPARATUS

(71) Applicant: Terra Studio LTD., Herzliya (IL)

(72) Inventors: Eran Zarhi, Kfar HaHoresh (IL); Elad Burko, Valley Stream, NY (US)

(21) Appl. No.: 17/233,770

(22) Filed: Apr. 19, 2021

(51) Int. Cl. A01G 31/02; A01G 24/40

(52) U.S. Cl. CPC A01G 31/02; A01G 24/40; A01G 2031/006

(57) ABSTRACT

A system including a plant apparatus for plant growth comprising: an internal volume configured to retain liquid; and an exterior surface having a plurality of indentations that are suitable for retaining seeds therein, wherein the exterior surface is made from a porous material enabling the liquid to seep out from the internal volume to the indentations of the exterior surface, wherein the exterior surface enables proliferation of plants thereacross.

### TECHNICAL FIELD

The present invention relates to a plant apparatus for plant growth, and more particularly, to a hollow plant apparatus for plant growth that diffuses liquid in a regulated manner to an exterior surface thereof.

### BACKGROUND

Various types of pots and vessels may support plant growth. Most enclose a volume to support a potting medium. Ceramic pots and vessels typically include soil and a plant rooted in the soil.

### BRIEF SUMMARY

One exemplary embodiment of the disclosed subject matter is a system comprising: a plant apparatus for plant growth comprising: an internal volume configured to retain liquid; and an exterior surface having a plurality of indentations that are suitable for retaining seeds therein, wherein the exterior surface is made from a porous material enabling the liquid to seep out from the internal volume to the indentations of the exterior surface, wherein the exterior surface enables proliferation of plants thereacross.

Optionally, the plant apparatus is configured to be suspended on a vertical surface, wherein the plant apparatus further comprises a sealed back portion that prevents the liquid from seeping out from the internal volume to the vertical surface.

Optionally, the plant apparatus is open-topped, enabling liquid from above the plant apparatus to enter the internal volume.

Optionally, the system comprises the plant apparatus and a second plant apparatus, wherein the second plant apparatus is configured to be hung on the vertical surface above the plant apparatus, wherein excess liquid from the second plant apparatus is directed to the internal volume of the plant apparatus.

Optionally, the excess liquid is provided from an exterior surface of the second plant apparatus, from an overflow of a top opening of the second plant apparatus, or from a porous lowermost edge of the second plant apparatus.

Optionally, the exterior surface of the plant apparatus further includes one or more sealed portions that prevent the liquid from passing therethrough, wherein plant growth is inhibited upon the one or more sealed portions.

Optionally, the one or more sealed portions comprise partial sealing of one or more indentations of the plurality of indentations, wherein the partial sealing enables a reduced amount of liquid to seep out through the one or more indentations.

Optionally, the one or more sealed portions comprise partial sealing of one or more indentations of the plurality of indentations, wherein the plant apparatus comprises a graduated sealing of the exterior surface comprising at least a minimum sealing changing to a maximum sealing, said minimum sealing disposed above the maximum sealing, thereby enabling to equalize a hydrostatic pressure within the plant apparatus.

Optionally, the plant apparatus comprises a graduated depth of the exterior surface comprising at least a minimum thickness gradually changing to a maximum thickness, said minimum thickness disposed above the maximum thickness, whereby a hydrostatic pressure of the liquid within the plant apparatus is influenced by the graduated depth of the exterior surface.

Optionally, the graduated depth is created by gradually altering depths of the plurality of indentations, wherein the minimum thickness corresponds to a deep shape and the maximum thickness corresponds to a shallow shape.

Optionally, the graduated depth is created by gradually altering dimensions of the plurality of indentations, wherein the minimum thickness corresponds to a large indentation diameter and the maximum thickness corresponds to a small indentation diameter that is smaller than the large indentation diameter.

Optionally, the large indentation diameter and the small indentation diameter have a same shape.

Optionally, the graduated depth is created by gradually altering shapes of the plurality of indentations, wherein the minimum thickness corresponds to a sharp shape and the maximum thickness corresponds to a round shape.

Optionally, the plant apparatus comprises hydrophobic material that is configured to direct a flow of liquid to one or more designated locations, wherein said plant apparatus is placed above one or more plant apparatuses, wherein direction of the liquid towards the one or more plant apparatuses is dictated by the hydrophobic material in the plant apparatus.

Optionally, the system comprises the plant apparatus and one or more plant apparatuses, wherein the plant apparatus and the one or more plant apparatuses are connected with one another using a pipe configuration, wherein irrigation of the one or more plant apparatuses is enabled via the plant apparatus and the pipe configuration.

Optionally, the system comprises the plant apparatus and a second plant apparatus, wherein said second plant apparatus is placed in parallel to the plant apparatus, wherein an irrigation source of the plant apparatus enables irrigation of the second plant apparatus via one or more pipes connecting the second plant apparatus to the plant apparatus.

Optionally, the system comprises a set of plant apparatuses comprising the plant apparatus, wherein the set of plant apparatuses comprises a first group of plant apparatuses that is configured to be utilized for a first type of plant associated with a first irrigation requirement and a second group of plant apparatuses that is configured to be utilized for a second type of plant associated with a second irrigation requirement, wherein the first group of plant apparatuses comprises a first porousness level that matches the first irrigation requirement, and the second group of plant apparatuses comprises a second porousness level that matches the second irrigation requirement.

Optionally, a method comprises: determining an irrigation setting for a set of plant apparatuses comprising the plant apparatus, wherein the set of plant apparatuses comprises a first group of plant apparatuses having a first porousness level and a second group of plant apparatuses having a second porousness level, wherein said determining is based on the first and second porousness levels; and applying the irrigation setting for irrigating the set of plant apparatuses.

Optionally, applying the irrigation setting comprises inserting hydrophobic material in the set of plant apparatuses.

Optionally, applying the irrigation setting comprises setting an irrigation quantity or frequency in an automatic irrigation system.

Optionally, the plant apparatus comprises a lid member configured to seal a top opening of the plant apparatus, wherein the lid member comprises an internal liquid level sensor configured to measure a liquid level within the internal volume, wherein an exterior surface of the lid member comprises a light sensor configured to measure an exposure level of the lid member to light.

Optionally, the lid member is configured to signal the liquid level and the exposure level to a user via a signaling mechanism.

Optionally, the signaling mechanism is at least one of: a buoy, a side pipe, or indication lights, wherein the side pipe is parallel to a longitude axis the plant apparatus and has fluid communication with the internal volume.

Optionally, the plant apparatus comprises a base member disposed basally supporting a body of the plant apparatus, wherein the base member is configured to accumulate excess liquid from the plant apparatus, wherein the base member comprises an ultrasonic transducer configured to evaporate excess liquid from the base member.

Optionally, the plant apparatus comprises an internal air compressor and an internal air pump configured to control an air pressure within the plant apparatus, thereby influencing a rate of liquid flow from the internal volume to the exterior surface.

Optionally, the plant apparatus comprises a top air pump and a bottom air pump, wherein the top air pump and the bottom air pump are placed in different height gradients, wherein said top and bottom air pumps are configured to control an air pressure within the plant apparatus, thereby influencing a rate of liquid flow from the internal volume to the exterior surface, wherein said top air pump is configured to increase the air pressure and said bottom air pump is configured to decrease the air pressure.

Optionally, the plant apparatus comprises a ceramic filter configured to be placed on a top opening of the plant apparatus.

Optionally, the plant apparatus comprises a liquid reservoir tank that is configured in size and shape to be placed above the ceramic filter, whereby liquid in the liquid reservoir tank is filtered by said ceramic filter before flowing to said internal volume of the plant apparatus.

Optionally, the plant apparatus comprises a mesh that is configured to be coupled to the plant apparatus around the exterior surface, wherein the seeds are enabled to be retained in the plurality of indentations below the mesh or inside pores of the mesh, thereby providing a dark environment for roots of the plants.

Optionally, the plant apparatus is configured to have a plant plug attached thereto, wherein one dimension of the plant plug is one centimeter or less, wherein the one dimension is a width, a length, or a depth.

Optionally, a method comprises obtaining a mesh, wherein the mesh is configured to be dressed on the plant apparatus; and dressing the mesh around the plant apparatus, wherein the mesh is tightly coupled to the plant apparatus.

Optionally, the mesh comprises embedded seeds, and the method comprises, after performing said dressing, inserting liquid to the internal volume in order to germinate the seeds.

Optionally, the method comprises obtaining seeds and inserting the seeds to the indentations prior to performing said dressing, whereby the mesh holding the seeds in the indentations.

Optionally, a method comprises obtaining a plant kit, the plant kit comprising: the plant apparatus; a plant carpet comprising a carpet of live flora, wherein a depth of the plant carpet is below a threshold, wherein the plant carpet is absent of soil; and a coupling medium configured to couple the plant carpet to the exterior surface; and dressing the carpet around the plant apparatus using the coupling medium, thereby causing roots of the plant carpet to anchor to the exterior surface.

Optionally, the threshold is 1 centimeter.

Optionally, the coupling medium comprises a rubber band, a button, or a zipper.

Optionally, the plant apparatus comprises an open-topped body bounding the internal volume.

Optionally, the body of the plant apparatus comprises a ceramic body.

Optionally, the body comprises a porous material such as clay, polymer, concrete, resin, fabric, microfiber, or the like.

Optionally, the indentations comprise a geometric array disposed over the exterior surface.

Another exemplary embodiment of the disclosed subject matter is a plant apparatus for plant growth comprising: an internal volume configured to retain liquid; and an exterior surface having a plurality of indentations that are suitable for retaining seeds therein, wherein the exterior surface is made from a porous material enabling the liquid to seep out from the internal volume to the indentations of the exterior surface, wherein the exterior surface enables proliferation of plants thereacross.

Yet another exemplary embodiment of the disclosed subject matter is a system comprising a plant plug, the plant plug comprising a plant and soil, wherein one dimension of the plant plug is one centimeter or less, wherein other dimensions of the plant plug are two centimeter or more.

Optionally, the system comprises a plant plug tray comprising a plurality of individual cells, wherein each cell comprising a plant plug including the plant plug.

Optionally, the one dimension is a depth of the plant plug, defined by a cell in which the plant plug was grown.

Optionally, the one dimension is a width or length of the plant plug, defined by a cell in which the plant plug was grown.

Yet another exemplary embodiment of the disclosed subject matter is a mold for slip casting a plant apparatus, wherein the mold has patterns configured to form a plurality of corresponding indentations in inserted liquid clay of the plant apparatus, wherein the plurality of indentations are suitable for retaining seeds therein, wherein the patterns are configured to form a graduated depth of an exterior surface of the plant apparatus that gradually increases a depth from a top of the exterior surface to a bottom of the exterior surface, wherein the mold is configured to form the plant apparatus comprising: an internal volume configured for retaining liquid; and the exterior surface, wherein the exterior surface is made of a porous material enabling liquid to seep out from the internal volume to the indentations of the exterior surface, wherein the exterior surface enables proliferation of plants thereacross.

Optionally, the patterns are configured to form gradually altering indentation shapes, depths, or sizes in the inserted liquid clay, wherein the slip casting is performed for a unified timeframe.

Yet another exemplary embodiment of the disclosed subject matter is a plant apparatus for plant growth comprising: an internal volume configured for liquid storage; and an exterior surface having a plurality of thorn-shaped bulges, wherein the exterior surface is made of a porous material enabling liquid to seep out from the internal volume to the bulges of the exterior surface, wherein the exterior surface enables proliferation of plants thereacross, wherein the bulges enable anchoring of the plants to the plant apparatus.

### BRIEF DESCRIPTION OF THE FIGURES

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A illustrates a front elevation view of a plant apparatus, according to some embodiments of the presently disclosed subject matter.

FIG. 1B illustrates a front elevation view of a plant apparatus separated from a lid and a base member, according to some embodiments of the presently disclosed subject matter.

FIG. 2A illustrates a detailed view of a plant apparatus and flora growing thereupon, according to some embodiments of the presently disclosed subject matter.

FIG. 2B illustrates a detailed view of a plurality of textural grooves informing the tessellated exterior surface of the plant apparatus, according to some embodiments of the presently disclosed subject matter.

FIG. 3A illustrates a raised elevation view of a plant apparatus with and without flora growing thereupon, according to some embodiments of the presently disclosed subject matter.

FIG. 3B illustrates a raised perspective view of an open top of a plant apparatus having a tile embodiment with irregular tessellations, according to some embodiments of the presently disclosed subject matter.

FIG. 3C illustrates a detail view of an exterior surface of a plant apparatus having irregular tessellations, according to some embodiments of the presently disclosed subject matter.

FIG. 4 illustrates a front elevation view of a plant apparatus having flora growing thereupon, according to some embodiments of the presently disclosed subject matter.

FIG. 5 illustrates a front elevation view of a plant apparatus employing an exemplary geometric pattern, according to some embodiments of the presently disclosed subject matter.

FIGS. 6A-6D illustrate plant apparatuses of regular and irregular tessellated indentations, according to some embodiments of the presently disclosed subject matter.

FIG. 7 illustrates a front elevation view of a matrix slip cast interior, according to some embodiments of the presently disclosed subject matter.

FIG. 8 illustrates a front elevation view of a slip cast mold having one side removed, according to some embodiments of the presently disclosed subject matter.

FIG. 9 illustrates a longitudinal cross-section of a plant apparatus showing a graduated cross-section between a minimum thickness and a maximum thickness bounding an interior volume, according to some embodiments of the presently disclosed subject matter.

FIG. 10 illustrates a schematic raised elevation view of the longitudinal cross-section of the plant apparatus, according to some embodiments of the presently disclosed subject matter.

FIGS. 11A-11B illustrate a longitudinal cross-section of a plant apparatus, according to some embodiments of the presently disclosed subject matter.

FIGS. 12A-12B illustrate longitudinal cross-sections of plant apparatus configurations, according to some embodiments of the presently disclosed subject matter.

FIG. 13 illustrates a longitudinal cross-section of a plant apparatus with a lid member, according to some embodiments of the presently disclosed subject matter.

FIG. 14 illustrates a cross-section of a base member, according to some embodiments of the presently disclosed subject matter.

FIG. 15 illustrates a longitudinal cross-section of a plant apparatus with water pressure control, according to some embodiments of the presently disclosed subject matter.

FIG. 16 illustrates a schematic front elevation view of a tile apparatus and a corresponding base member, according to some embodiments of the presently disclosed subject matter.

FIG. 17A illustrates a schematic raised elevation view of an external front surface of a tile apparatus, according to some embodiments of the presently disclosed subject matter.

FIG. 17B illustrates a schematic raised elevation view of a back surface of a tile apparatus, according to some embodiments of the presently disclosed subject matter.

FIG. 18 illustrates a schematic front view and a side view of a tile apparatus, according to some embodiments of the presently disclosed subject matter.

FIG. 19 illustrates a schematic front view of water level detectors, according to some embodiments of the presently disclosed subject matter.

FIG. 20 illustrates a schematic front view of a tile assembly, according to some embodiments of the presently disclosed subject matter.

FIG. 21 illustrates a schematic front view and a side view of a tile assembly, according to some embodiments of the presently disclosed subject matter.

FIG. 22 illustrates a schematic front view of a tile assembly, according to some embodiments of the presently disclosed subject matter.

FIG. 23 illustrates a schematic front view of an irrigation configuration of a parallel tile assembly, and a side view of a tile, according to some embodiments of the presently disclosed subject matter.

FIG. 24 illustrates a schematic front view of a mixed vase and tile assembly, according to some embodiments of the presently disclosed subject matter.

FIG. 25 illustrates a schematic front view of a non-hangable tile, according to some embodiments of the presently disclosed subject matter.

FIG. 26 illustrates a schematic front view of a non-hangable tile assembly, according to some embodiments of the presently disclosed subject matter.

FIG. 27 illustrates a longitudinal cross-section of a limescale filtering configuration, according to some embodiments of the presently disclosed subject matter.

FIG. 28 illustrates a longitudinal cross-section of a customized configuration of a plant apparatus, according to some embodiments of the presently disclosed subject matter.

FIG. 29 illustrates a schematic front view of a mesh that is configured for covering a plant apparatus, according to some embodiments of the presently disclosed subject matter.

FIG. 30 illustrates a schematic view of plant plugs configured to be coupled to a plant apparatus, according to some embodiments of the presently disclosed subject matter.

FIG. 31 illustrates a schematic exploded view and a front elevation view of a modular plant apparatus, according to some embodiments of the presently disclosed subject matter.

FIG. 32 illustrates a longitudinal cross-section view of a plant apparatus, according to some embodiments of the presently disclosed subject matter.

FIG. 33 illustrates a schematic exploded view and a front elevation view of a modular plant apparatus, according to some embodiments of the presently disclosed subject matter.

### DETAILED DESCRIPTION

One technical problem dealt with by the disclosed subject matter is to provide a user-friendly plant apparatus for flora growth that enables to grow flora easily and reliably, without necessarily requiring frequent irrigation, soil, water treatment, or the like. In some exemplary embodiments, it may be desired to reduce or minimize user involvement in the flora growth process without compromising on a health of the flora, a reliability of its growth, on an esthetic appearance of the plant apparatus, or the like.

Another technical problem dealt with by the disclosed subject matter is to equalize a liquid or water pressure within a hollow plant apparatus, so that the liquid, e.g., water or any other fluid, is distributed equally within the apparatus, through a porous apparatus wall, and to an exterior surface on which flora may anchor. In some exemplary embodiments, in case that a wall thickness of a plant apparatus is uniform, the liquid may concentrate and drain mostly in a bottom portion of the body of the plant apparatus, e.g., in accordance with the hydrostatic pressure, creating an uneven liquid distribution to the exterior surface. This phenomenon may be especially noticeable for a plant apparatus of a capacity that overpasses three liters, a capacity that overpasses 1.5 liters, and in some cases for a capacity of less than 1 liter. It may be desired to control the water pressure in each area of the plant apparatus, to equalize the water pressure, or the like.

Yet another technical problem dealt with by the disclosed subject matter is to automatically enhance a liquid utilization of system, e.g., by minimizing an unnecessary liquid utilization, utilizing the liquid resources efficiently, reusing excess liquid, or the like.

Yet another technical problem dealt with by the disclosed subject matter is to provide signals to the client, indicating parameters of the system that require user intervention such insufficient liquid, insufficient light, or the like. In some exemplary embodiments, the plant apparatus may not be transparent, and in some cases may be hung up a wall which may be unreachable, high, or the like. Accordingly, it may difficult to perceive the current liquid level, or other parameters of the plant apparatus. It may be desired to indicate to the user parameters of interest in order to overcome such drawbacks, e.g., in case the plant apparatus is not transparent.

Yet another technical problem dealt with by the disclosed subject matter is to customize an appearance of one or more plant apparatuses, a configuration thereof, a shape of a flora growing thereof, or the like. For example, it may be desired to control areas of a plant apparatus on which flora growth is enabled, thereby enabling to form live patterns, shapes, or the like. As another example, it may be desired to enable installation of plant apparatuses in a desired assembly shape or configuration, e.g., in a triangle configuration or in any other configuration. Additionally or alternatively, it may be desired to customize a structure of a plant apparatus and components thereof to match needs of specific plant types. For example, it may be desired to customize a shape of a plant apparatus, a depth thereof, a material thereof, or the like, to match various liquid requirements, anchoring support requirements enabling the plant to hold on to the plant apparatus, darkness requirements, or the like.

Yet another technical problem dealt with by the disclosed subject matter is to enable easy, flexible, and swift installation of a system including one or more plant apparatuses and irrigation sources that can fulfil the irrigation needs of the system. For example, in case a living wall is desired, it may be desired to enable swift and simple installation of plant apparatuses on a wall.

One technical solution of the disclosed subject matter is a hollow plant apparatus or system for plant growth that includes an exterior surface having a plurality of indentations (also referred to as cells, grooves, slots, or the like) thereupon wherein seeds may be housed, retained therein, anchored therein upon germination, or the like. In some exemplary embodiments, the plant apparatus may comprise an internal volume configured for liquid storage, for retaining liquid, or the like. In some exemplary embodiments, the indentations on the exterior surface may not be deep enough to penetrate into the internal volume, but rather may comprise shallow indentation or grooves that partially penetrate in the exterior surface, thereby providing the internal volume with a solid casing. In some exemplary embodiments, the exterior surface may be composed of, or be made from, a porous material enabling liquid to seep out from the internal volume to the indentations of the exterior surface. In some exemplary embodiments, the exterior surface may enable proliferation of plants thereacross, which may be irrigated via the indentations and anchored thereto. In some exemplary embodiments, the areas around or between the indentations may be sealed against liquid drain.

In some exemplary embodiments, the exterior surface may employ a plurality of tessellated indentations, e.g., in geometric array thereover, where seeds may be supportively upheld until germination therein. In some exemplary embodiments, the exterior surface may comprise alternative configurations in which germinated or grown plants are attached to the exterior surface, without necessarily enabling to house seeds in the indentations, necessarily comprising the indentations, or the like. Various species of plants may be germinated and grown upon the exterior surface of the plant apparatus simply by addition of liquid to the internal liquid storage volume, e.g., after inserting seeds to the indentations, coupling seeds to the exterior surface, coupling flora roots to the exterior surface, or the like. The plant apparatus may enable growth and proliferation of plants across an exterior surface of the plant apparatus itself, e.g., without necessarily requiring soil or another potting medium.

In some exemplary embodiments, the plant apparatus may be implemented as a vase, a wall tile that is sealed in one side, a tile-shaped vase, part of an assembly of plant apparatuses, or any other configuration of interest. In some exemplary embodiments, the plant apparatus may comprise an open-topped body bounding the internal volume, a base portion disposed basally for supporting the body of the plant apparatus, a lid member securable to enclose the open-topped body of the plant apparatus, or the like. In some exemplary embodiments, the plant apparatus may be sealed at the bottom, such as using a sealed base member, sealing material within a body of the plant apparatus, or the like. A sealed base member may be composed of non-porous material, and may be configured to collects excess water that drips down the external surface of the body. In some cases, the plant apparatus may have a bottom or lowermost edge that is non-porous, that is fully or partially open, a closed bottom being composed of porous material enabling liquid transfer, or the like.

In some exemplary embodiments, multiple plant apparatuses, including at least some apparatuses that enable liquid transfer to tiles below them, may collaborate to form a joint setting or assembly, such as a setting in which wall tiles feed the tiles below them with excess liquid, in which a pipe configuration connects multiple plant apparatuses to a single irrigation source, or the like. In some exemplary embodiments, an irrigation source of a plant apparatus or assembly thereof may comprise a liquid pipe, a drip irrigation system, a gutter, a dropper, a faucet, or any other irrigation source. In some cases, hydrophobic material may be used to control the direction and rate of the liquid flow between the tiles, enabling to set the tiles in a customized configuration, to match irrigation needs of different plant types, of the like.

In some exemplary embodiments, the plant apparatus may include regular or irregular tessellated indentations, grooves, or the like, on its exterior surface. In some exemplary embodiments, the grooves may include one or more grooves that are partially or fully sealed, areas between the grooves that are partially or fully sealed, or the like. In some exemplary embodiments, plant growth upon the exterior surface may be controlled along tessellations and between glazed, glossy, or otherwise sealed portions of the exterior surface, thereby enabling to form living designs rendered by the plant growth. In some exemplary embodiments, inhibiting plant growth upon some portions of the exterior surface while encouraging growth on others may enable growth of plants into elaborate designs and geometric arrays, reduce a liquid utilization, equalize a water pressure, or the like. In some exemplary embodiments, small portions of the grooves may be sealed, thereby reducing a pace of liquid that seeps out to the exterior surface while providing sufficient liquid resources to satisfy needs of the flora. In some exemplary embodiments, grooves that are fully sealed may not enable growth of flora thereon, but may be sealed anyhow in order to form a living design matching a desired pattern.

In some exemplary embodiments, the plant apparatus may include one or more mechanisms configured to equalize liquid pressure over the porous walls. In some exemplary embodiments, the porous walls may be partially sealed, by gradually sealing more portions of the lower porous walls, and sealing less portion of the top porous walls, e.g., in a gradual gradient, thereby reversing the hydrostatic pressure. In some exemplary embodiments, the liquid pressure may be equalized or controlled using gradually altering wall depths (also referred to as wall width or wall thickness) of the plant apparatus, using gradually altering groove shapes that correspond to different wall depths, using gradually altering groove dimensions, using gradually altering groove depths, using internal pumps within the plant apparatus in order to control the air pressure that affects the liquid pressure, a combination thereof, or the like. For example, in case the cells or grooves are each surrounded with sealing material, the lower portions may include smaller cells with a large proportion of sealing therebetween, e.g., with a same shape, width, or the like. The cells may become gradually larger in dimension as the height increases, having maximal-sized cells at a top most portion of the porous walls, with minimal sealing therebetween. This way, the bottom area of the side walls may have a large overall sealed area (compared to the remaining areas), comprising the sealing between the small cells, thereby balancing the hydrostatic pressure, and preventing from mass hydrostatic pressure to concentrate at the bottom.

In some exemplary embodiments, the porous walls of the exterior surface may be structured to have gradual depths, thickness, widths, or the like, changing gradually from a minimal thickness to a maximum thickness. In some exemplary embodiments, the maximum thickness may be disposed at a location that is more proximal to the base portion than the location at which the minimum thickness is disposed, e.g., thereby balancing the liquid pressure. In some exemplary embodiments, the minimum thickness may be disposed at a location that is more proximal to the top opening of the plant apparatus than the location at which the maximum thickness is disposed. In some exemplary embodiments, the graduated depths may influence or reverse a hydrostatic pressure of the liquid within the plant apparatus. In some exemplary embodiments, the graduated depths may be created by gradually altering shapes, depths, or sizes of the plurality of indentations. For example, the minimum thickness may correspond to a sharp deep indentation shape while the maximum thickness may correspond to a round shallow indentation shape. As another example, the minimum thickness may correspond to a large indentation diameter having a large dimension and/or depth while the maximum thickness may correspond to a small indentation diameter that is smaller than the large indentation diameter. In some exemplary embodiments, any other combination or configuration may be used to provide a gradually altering depth.

In some exemplary embodiments, the plant apparatus may include one or more monitoring sensors configured to monitor or measure parameters of interest such as a liquid level, a light level, or the like. In some exemplary embodiments, one or more computing devices or chips may be configured to communicate with the sensors, obtain sensor information therefrom, and indicate the sensor information to the client, e.g., upon obtaining an event such as insufficient liquid level, a problem with the irrigation source, or the like. In some exemplary embodiments, the indicated parameter values or events may be indicated using one or more visual cues such as using indicator lights with different colors, indicator lights placed at certain locations, light patterns with different patterns for each message, or the like. In some exemplary embodiments, the indicator lights may be placed on each plant apparatus, at a central unit communicating with each plant apparatus, or the like. In some exemplary embodiments, the indicated parameter values or events may be indicated using one or more audio cues, directly via a radio communication medium, or the like. In some exemplary embodiments, mechanical methods may be used to indicate parameters of interest such as a liquid level, e.g., by using a liquid meter such as a buoy floating on the liquid level, a transparent side pipe, or the like.

In some exemplary embodiments, in order to prevent excess liquid from standing or being retained for long periods of time in the plant apparatus, one or more internal evaporating components of the plant apparatus may be configured to evaporate the excess liquid, e.g., from the base member of the plant apparatus or from any other location accumulating excess liquid. For example, excess fluid may be accumulated at a base member, a gutter, a pipe configuration, or the like. In some exemplary embodiments, an evaporating component may comprise, for example, an ultrasonic transducer (also referred to as an ultrasonic speaker or oscillator) that is configured to evaporate liquid using high frequency vibration produced by piezoelectric transducers that create capillary waves in a liquid film. For example, an ultrasonic transducer may comprise a ceramic piece covered in copper that vibrates similarly to an ultrasonic spray nozzle or a humidifier. In some exemplary embodiments, any other evaporating component may be used. In some exemplary embodiments, in order to prevent from excess liquid to be retained for long periods of time in the base member of the plant apparatus, the excess liquid may be returned from the base member to the body of the plant apparatus, e.g., using a pipe. In some exemplary embodiments, any other technique may be used to reuse or remove excess liquid concentrated in an area of the plant apparatus or the irrigation configuration.

In some exemplary embodiments, the plant apparatus may be customized to include one or more portions, components, additions, or the like, which may be configured to match needs of specific plant types. In some exemplary embodiments, a size, shape, and depth of the indentations on the exterior surface may be customized to match a rate of liquid that is required for a plant type. In some exemplary embodiments, larger indentations may enable flora anchoring to the indentations to accumulate more liquid, and vice versa. In some exemplary embodiments, a material of the plant apparatus may be modified or selected to match a desired porousness, a desired anchoring level, or the like. For example, ferns that require much liquid may be matched with high porousness apparatuses, while orchids that require less liquid may be matched with lower-porousness apparatuses. In some exemplary embodiments, soil may be added on the exterior surface, e.g., matching plant types that require soil. In some exemplary embodiments, as some plant types may grow their roots in darkness only, a mesh component may be added around the plant apparatus, providing a dark environment for the roots while anchoring the flora to the plant apparatus.

One technical effect of the disclosed subject matter is providing a user-friendly plant apparatus for flora growth that is easily maintained and installed in various flexible configurations. The plant apparatus may provide user indications regarding the liquid level thereof, the light exposure, or the like, which may simplify its maintenance.

Another technical effect of the disclosed subject matter is enabling to equalize a water pressure within a plant apparatus using various methods such as a depth gradient, altering groove sizes, depths, and shapes, partial sealing of indentations, internal pumps controlling the internal air pressure, or the like. This enables to overcome the unequal hydrostatic pressure distribution in different heights of the plant apparatus, and provide equal liquid supply to each area. In some cases, modifying a shape or pattern of the indentations may affect the size of the external surface, and thereby affect the liquid distribution thereto.

Yet another technical effect of the disclosed subject matter is enabling to customize a living design of flora on the plant apparatus using sealing material blocking one or more grooves, portions thereof, or the like. The sealing material may also be used to reduce a liquid utilization and an irrigation frequency, by slowing down the liquid drain through the partially sealed porous grooves. The plant apparatus may also be customized to various plant needs, enabling growth of an extremely wide variety of flora. In some cases, different portions of the plant apparatus may be suited for respective types of plants, and marked accordingly. For example, a top body area of the plant apparatus may be less wet than the bottom body area, and may match flora that require moist but not soggy surface, such as orchids, while the bottom wall area of the plant apparatus may exhibit a moister or even wet surface, which may match needs of certain plant types such as ferns. According to this example, the top area may be marked as drier, and the bottom portion may be marked as wetter. As an example, the marking may be provided using visible markings on the different areas, using different colors or texture, using cell patterns of different shapes representing different moisture levels, or the like. Additionally or alternatively, any other parameter of an area of the plant apparatus may be marked, e.g., a size of the proliferation area, a water pressure of each area, an anchoring property of each area, or the like.

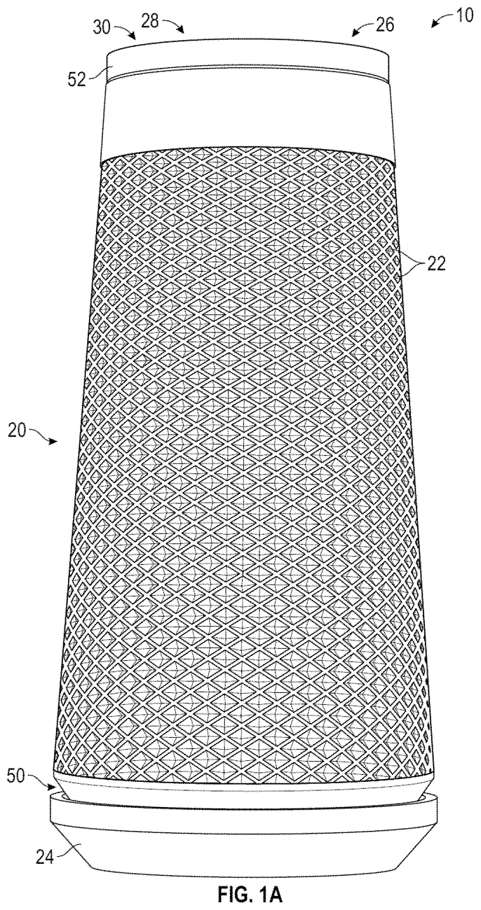

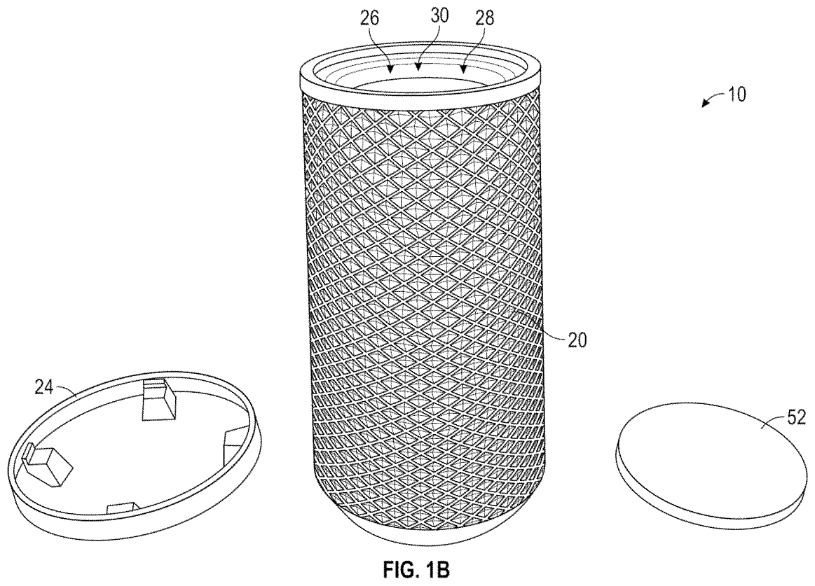

With reference now to the drawings, and in particular FIGS. 1 through 30 thereof, examples of the tessellated plant apparatuses for plant growth employing the principles and concepts of the present tessellated plant apparatus for plant growth are described.

Referring now to FIGS. 1A and 1B, illustrating a front elevation view of a Plant Apparatus 10 structured as a vase, according to some embodiments of the presently disclosed subject matter. Plant Apparatus 10 may be structured or implemented as any hollow structure that enables liquid to seep or drift from an interior portion to external walls of the structure. The Plant Apparatus 10 includes an Open Top 26 providing access to an Interior Volume 28 of the Plant Apparatus 10, coextensive with a liquid Storage Volume 30 (also referred to as Internal Volume 30), wherein liquid is storable interior to the Plant Apparatus 10. In some exemplary embodiments, the Internal Volume 30 may enable liquid to diffuse in a regulated manner to the Exterior Surface 20 and thereby feed any flora growing upon tessellated Indentations 22 of the Exterior Surface 20. In some exemplary embodiments, the Exterior Surface 20 of the Plant Apparatus 10 may facilitate the anchoring of roots thereupon, to support plant growth of various species upon the Exterior Surface 20, while enabling the diffusion of liquid from the associated Internal Volume 30 of liquid storage through the porosity of the Plant Apparatus 10 to become available for plants proliferating upon the Exterior Surface 20.

The generally conical, the Exterior Surface 20 of Plant Apparatus 10 illustrated in FIGS. 1A and 1B includes a plurality of tessellated Indentations 22 disposed in geometric array thereover. Each of the tessellated Indentations 22 in the Plant Apparatus 10 illustrated in FIGS. 1A and 1B may be lozenge-shaped, or have any alternative shape such as a round shape, a triangle shape, a square shape, a deep shape, a shallow shape, or the like. Each of the tessellated Indentations 22 in the Plant Apparatus 10 may include an ovoid depression or any other shaped depression wherein seeds of a corresponding sufficiently small size may be maintainable, insertable, or the like. A plurality of seeds (not shown) may be storable upon the Exterior Surface 20, interior to the plurality of tessellated Indentations 22. In some cases, a plurality of small-sized seeds, that are small enough to be inserted and germinated in a single tessellated indentation, may be inserted to a single tessellated Indentation 22, and remain therein when the Plant Apparatus 10 is placed upright upon its Base member 24, as shown in FIGS. 1A and 1B. In some cases, a single seed may be inserted to a single tessellated Indentation 22, some tessellated Indentations 22 may not be used for inserting seeds, or the like. Upon irrigation of the Plant Apparatus 10, when placed upright, the seeds may germinate.

The Plant Apparatus 10 depicted in FIG. 1B is separated from a lid member and a base member. Lid member 52 may be fitted to sealably enclose the Open Top 26 to prevent evaporation therethrough. The lowermost edge of Plant Apparatus 10 may be sealed or non-porous to prevent liquid from draining through the bottom or sides of the Plant Apparatus 10 and onto Base member 24. Base member 24 may be configured to receive any liquid draining out from Plant Apparatus 10, and to prevent the liquid from flowing to an underling surface such as a room floor. Open Space 50, disposed at the Base member 24, may serve to interrupt drainage by creating a discontinuity in the osmotic pressure exerted by the liquid head in the column of liquid stored within the Interior Volume 28. The underside of the base member or any other area thereof may be sealed and rendered impermeable, liquid-proofed, or the like. Alternatively, the entire base member may be sealed and rendered impermeable, liquid-proofed, or the like. Base member 24 may further serve to collect liquid draining over the Exterior Surface 20, from a top opening, or the like.

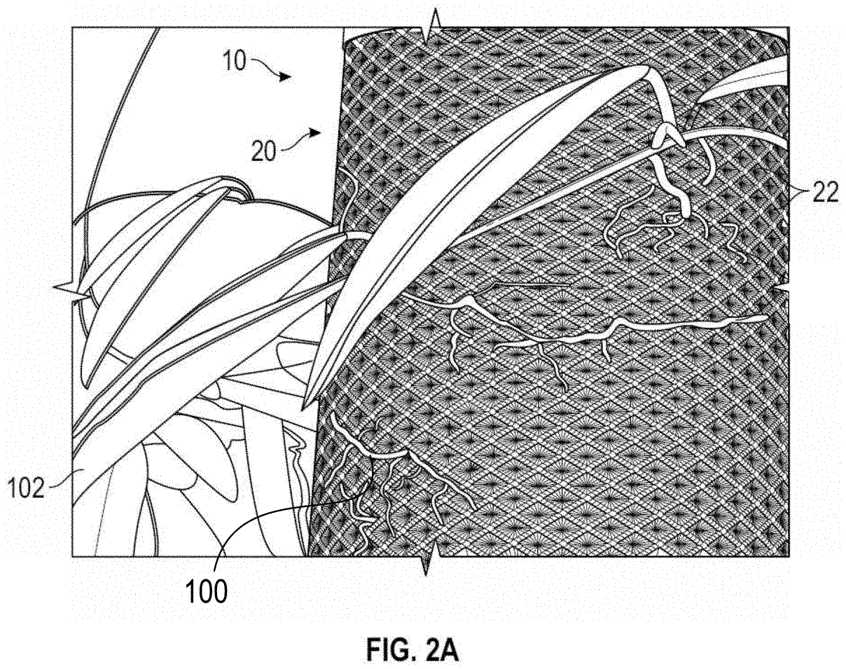

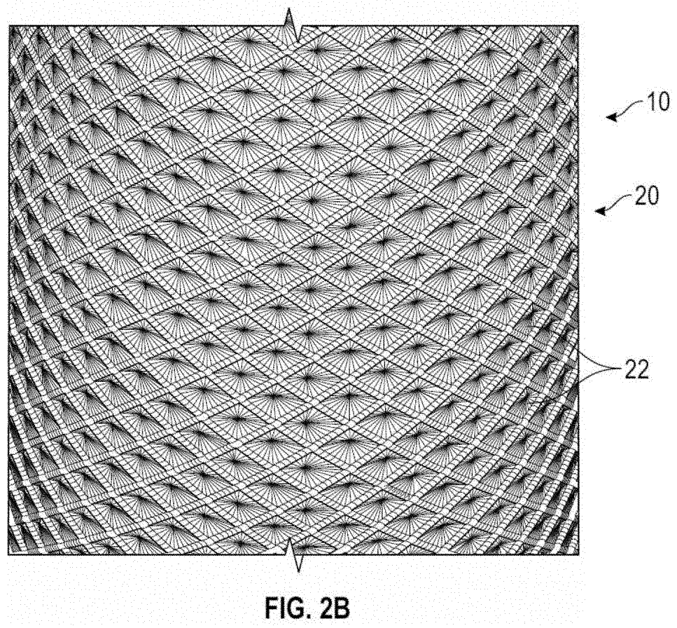

Referring now to FIGS. 2A and 2B, illustrating a detailed view of a Plant Apparatus 10 with Flora 102 growing thereupon, in accordance to some embodiments of the presently disclosed subject matter. Under hydrostatic pressure, liquid may drain transversely through the Apparatus 10, from the Interior Volume 28, through the porosity of the Apparatus 10, to the Exterior Surface 20 to render available liquid for seeds stored interior to the tessellated Indentations 22 and plants growing thereupon. Subsequent to germination of the seeds and development of Roots 100, the liquid may travel via capillary action and along an osmotic gradient through the Apparatus 10 to become available liquid for Roots 100 of Flora 102 anchoring to the tessellated Indentations 22. As depicted in FIG. 2B, the Exterior Surface 20 may include a plurality of textural grooves. Tessellated Indentations 22 may further comprise rough or uneven surface features such as a plurality of smaller grooves or other surface irregularities configured to assist in root anchoring thereto.

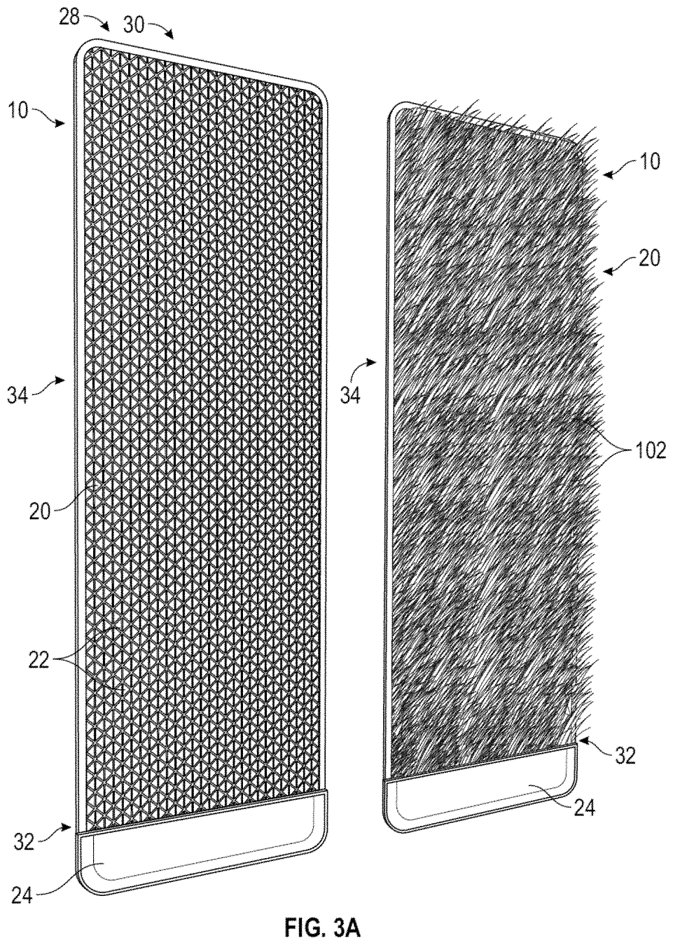

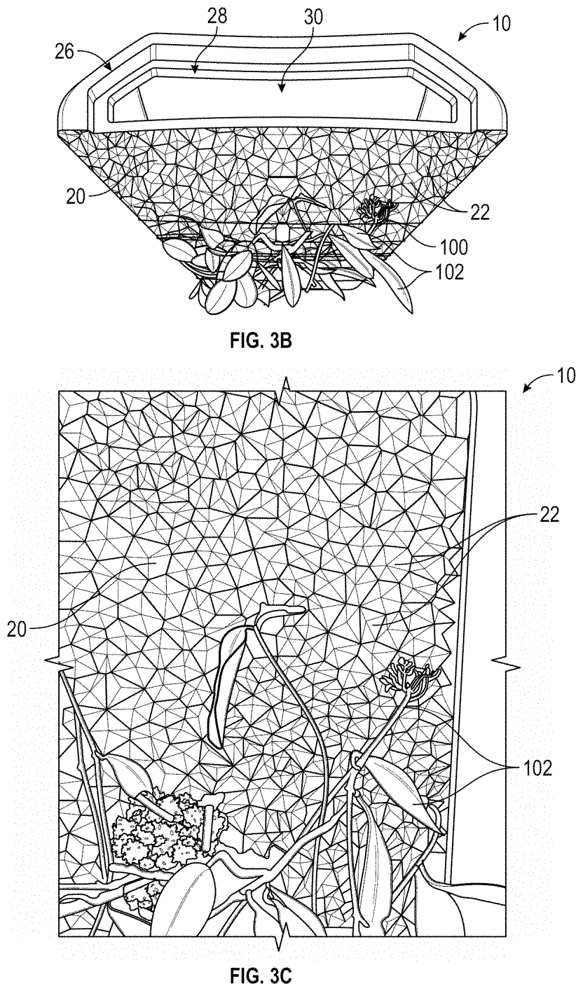

Referring now to FIGS. 3A, 3B, and 3C, illustrating views of various structures implementing a Plant Apparatus 10, in accordance to some embodiments of the presently disclosed subject matter. In some exemplary embodiments, as illustrated in FIGS. 3A, 3B, and 3C, the Plant Apparatus 10 may be structured as a hollow tile that can be attached or suspended on a vertical surface such as a wall, or placed on any other surface, at any location, or the like. In some exemplary embodiments, in case the Plant Apparatus 10 is configured to be attached to a vertical surface, the plant apparatus may further comprise a sealed back. In some cases, the sealed back may prevent leakage of the liquid through the back wall. Additionally, or alternatively, the sealed back may inhibit plant growth in the back wall of the body. In some exemplary embodiments, the sealed back portion may prevent the liquid from seeping out from the internal volume to the vertical surface. In some exemplary embodiments, the liquid Storage Volume 30 may be disposed coextensive with an Interior Volume 28 of the tile, accessible via an Open Top 26 and in fluid communication with the Exterior Surface 20 of the Plant Apparatus 10. A Base member 24 may be attachable at a lowermost Edge 32 of the Plant Apparatus 10, e.g., which may be lowermost when the Plant Apparatus 10 is in use. Base member 24 may be configured to capture liquid draining over the Exterior Surface 20 and moving, under the action of gravity, towards the lowermost Edge 32. The sealing on the Base member 24 of the vase may be a strong sealing of high quality, that can handle all the excess liquid exuding out to the base.

In some exemplary embodiments, in case the Plant Apparatus 10 has a sealed back portion that is configured to face a vertical surface such as a wall, and a non-sealed Exterior Surface 20 on the opposite side for enabling flora growth, the Exterior Surface 20 may be anteriorly disposed to outface from the wall upon which the Plant Apparatus 10 is suspended. In some exemplary embodiments, the Exterior Surface 20 includes a plurality of tessellated Indentations 22 disposed thereover, each suited to support at least one seed therein for germination as liquid moves through the Plant Apparatus 10 from the liquid Storage Volume 30, through the porosity of the Plant Apparatus 10, to the Exterior Surface 20. Water in the liquid Storage Volume 30, therefore, by action of osmotic pressure along a concentration gradient, is exuded at the Exterior Surface 20 to render available liquid for seeds disposed interior to each Indentation 22 and, subsequent germination of said seeds, to the Roots 100 of Flora 102 growing thereupon. In some exemplary embodiments, the excess liquid from the Exterior Surface 20 may exude to Base member 24.

FIG. 3A illustrates a raised elevation view of a Plant Apparatus 10 with and without Flora 102 growing thereupon, according to some embodiments of the presently disclosed subject matter. As illustrated in FIG. 3A, the anteriorly Exterior Surface 20 of the Plant Apparatus 10 may comprise homogenous tessellations, according to some embodiments of the presently disclosed subject matter. As illustrated in both FIG. 3B and FIG. 3C, Exterior Surface 20 of the Plant Apparatus 10 may comprise irregular or heterogenous tessellations, according to some embodiments of the presently disclosed subject matter.

FIG. 3B illustrates a raised perspective view of an open top of the Plant Apparatus 10 having a tile embodiment with irregular tessellations. The Plant Apparatus 10 may embody a tile which may or may not be configured to be attached to a vertical surface such as a wall.

FIG. 3C illustrates a detail view of an Exterior Surface 20 of the Plant Apparatus 10, according to some embodiments of the presently disclosed subject matter. As illustrated in both FIG. 3B and FIG. 3C, Exterior Surface 20 of the Plant Apparatus 10 may comprise irregular or heterogenous tessellations, according to some embodiments of the presently disclosed subject matter. As shown in FIGS. 3B and 3C, Indentations 22 may include tessellates with variations in form, array, pattern, and extent, including regular or irregular tessellations. In some exemplary embodiments, the irregular tessellations may provide enhanced anchoring to the Flora 102.

As illustrated in FIGS. 3A, 3B, and 3C, a basal side 34 of the Plant Apparatus 10 may be glossed, glazed, or otherwise sealed to prevent liquid exuding out said side 34 to contact the rearward wall upon which the Plant Apparatus 10 may be disposed. A back of each wall tile may be sealed similarly, preventing the wall from obtaining moisture, dampness, mildew, or the like. Additionally, the plurality of tessellated Indentations 22, by virtue of their indented cavities intruding into the Exterior Surface 20, may create an osmotic gradient that consistently leads the liquid to move from the Storage Volume 30 to the Exterior Surface 20, and drain to one side preferentially. Multiple tiles 10 may be suspended singly or en masse, to form a living wall aesthetically pleasing to viewers, and, when used indoors, beneficial in sustaining indoor air quality. Multiple tiles 10 may be suspended en masse so as to reduce irrigation or liquid resources, e.g., by providing excess liquid from one tile to the next.

In some exemplary embodiments, the Plant Apparatus 10 may be combined with a slow-release gel, which may be configured to reduce the use of liquid and fertilizer, or the like, e.g., reducing a frequency of irrigation to twice a year, four times a year, replacing irrigation entirely, or any other frequency of irrigation. In some exemplary embodiments, the gel may provide complementary or supplement irrigation or fertilization to the Flora 102. In some exemplary embodiments, the gel may enable to reduce irrigation, and may be used instead of liquid or in addition thereto. In some exemplary embodiments, gel may be inserted to the inner space of the Plant Apparatus 10, to exert out through corresponding openings, holes, or the like, which may replace the indentations or be an addition thereto, leading to the exterior surface. In some exemplary embodiments, the holes may be structured to be smaller at lower portions of the Plant Apparatus 10 and bigger atop, thereby enabling equal distribution or flow of the gel over the Exterior Surface 20. In some exemplary embodiments, the gel may be utilized for Apparatus 10 of various porous or even non-porous material, e.g., since the gel can move out through holes, and does not rely on a porousness of the Apparatus 10. Alternatively, gel may be spread on the external walls of Apparatus 10, in addition to inserting liquid to the interior space of Apparatus 10 with indentations and without holes. In this configuration, liquid irrigation may be reduced, compared to a typical configuration, by thickening the walls, so the liquid drains out slowly, enabling to reduce the irrigation frequency and total amount.

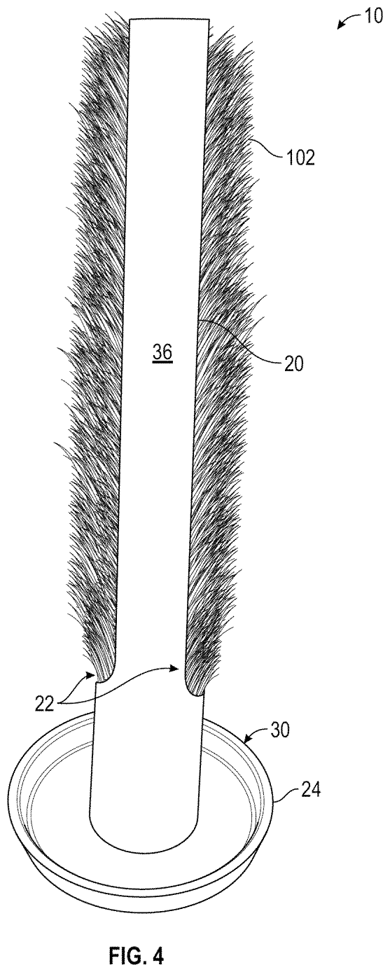

Referring now to FIG. 4, illustrating a front elevation view of a Plant Apparatus 10 having Flora 102 growing thereupon, according to some embodiments of the presently disclosed subject matter. In some exemplary embodiments, the liquid Storage Volume 30 may be coextensive with an interior volume of the Plant Apparatus 10. However, as illustrated in FIG. 4, the liquid Storage Volume 30 may also be disposed as liquid contained within the confines of Base member 24. In such an embodiment, liquid confined by the Base member 24 may be moved up the Plant Apparatus 10 under osmotic pressure and capillary action through the porosity of the Plant Apparatus 10 to exude out of portions of the Exterior Surface 20 that are unglazed, not glossed or otherwise not sealed from the movement of liquid. Thus, availability of liquid is controlled, and growth of the associated Flora 102 therefore is maintainable into certain patterns or areas upon the Exterior Surface 20 for reasons of aesthetic appeal, space utilization, or the like.

As illustrated in FIG. 4, the Plant Apparatus 10 enables to support Flora 102 upon specific portions of the Exterior Surface 20. In some exemplary embodiments, plant growth may be facilitated upon the Exterior Surface 20 but restricted from proliferation on specific portions of the Exterior Surface 20, e.g., which may be sealed. Restriction of plant growth may be effective by use of glazes, glosses, sealants, or other surface features that seal the porosity of the Plant Apparatus 10 over a desired expanse, and therefore prevent liquid availability thereat, or by other means to prevent root anchoring thereto. Thus, liquid from the liquid Storage Volume 30 within the Plant Apparatus 10 may be prevented from reaching certain areas of the Exterior Surface 20, but instead caused to drain or move under osmotic pressure to other parts of the Exterior Surface 20, whereby specific patterns may be embodied by the Flora 102 supported and growing upon the Exterior Surface 20. In some exemplary embodiments, the Plant Apparatus 10 may be selectively sealed in one or more portions of the Exterior Surface 20, thereby enabling the user to control the locations in which liquid drains out. In some exemplary embodiments, every portion of Exterior Surface 20 that is sealed, prevents liquid from passing therethrough, prevents plant anchoring thereto, or the like, thereby preventing plant growth or proliferation thereon. In some exemplary embodiments, plant growth may be inhibited upon the one or more sealed portions. In some exemplary embodiments, performing glazing of one or more portions of the Plant Apparatus 10 enables to control a proliferation, shape, pattern, or the like, of Flora 102, as plant growth is inhibited upon the sealed portions. In some exemplary embodiments, plant drawings may be formed according to the shape of the sealed areas. For example, mildew may be grown according to selected patterns of a design.

In some exemplary embodiments, portions of the tessellated Indentations 22 may be partially sealed without entirely blocking indentations that are in use of plants. In some exemplary embodiments, partially sealing the tessellated Indentations 22 may provide one or more technical benefits. In some exemplary embodiments, partially sealing one or more indentations may enable to reduce an amount of liquid or irrigation resources that seep out through the one or more indentations. For example, thin homogeneous or heterogeneous patterns of lines, points, pixels, or the like of the tessellated Indentations 22 may be sealed, rendered impermeable, or the like, thereby reducing the amount of liquid that is enabled to seep through the indentations without blocking entire cells of the tessellated Indentations 22. In some exemplary embodiments, the thin impermeable patterns may include patterns that are each not wider than a predetermined threshold, such as but not limited to 0.5 centimeter, 0.4 centimeter, or the like, patterns that are each not wider than a certain percentage of the corresponding indentation, or the like. For example, the patterns partially sealing one or more indentations may be configured to cover no more than a third of each indentation, or any other percentage. In some exemplary embodiments, by enabling limited liquid seepage via the tessellated Indentations 22, the Flora 102 may utilize liquid resources slower compared to a configuration with fully porous cells, thereby reducing the irrigation resources, the irrigation frequency, or the like.

In some exemplary embodiments, partial sealing may be utilized to balance a water pressure throughout the Plant Apparatus 10. In some exemplary embodiments, the water pressure within the Plant Apparatus 10 may be balanced by partially sealing a higher percentage of the tessellated Indentations 22 that are lower, and partially sealing a low percentage of the tessellated Indentations 22 that are higher, e.g., in a linear gradient. For example, all of the tessellated Indentations 22 at the lowest portion of the Plant Apparatus 10 may be partially sealed, while only a tenth of the highest portion of the Plant Apparatus 10 may be partially sealed. Alternatively, the water pressure within the Plant Apparatus 10 may be balanced by sealing a larger percentage of the tessellated Indentations 22 that are lower, and sealing a lower percentage of the tessellated Indentations 22 that are higher, e.g., in a linear gradient. In some exemplary embodiments, the sealing level may oppositely correlate to the water pressure on each height level of the Plant Apparatus 10. For example, each indentation at the lowest portion of the Plant Apparatus 10 may be 40% sealed, while each indentation at the highest portion of the Plant Apparatus 10 may be 10% sealed. As another example, the lowest tessellated indentations, when the Plant Apparatus 10 is placed upright upon its Base member 24, may be partially sealed to around 80% of each indentation, while the highest tessellated indentations, when the Plant Apparatus 10 is placed upright, may be partially sealed to around 5% of each indentation, in a gradual manner.

In some exemplary embodiments, partial sealing the Plant Apparatus 10 may include sealing borders between indentations. In some exemplary embodiments, in order to balance a liquid pressure throughout the Plant Apparatus 10, the higher the cell is located with respect to the Plant Apparatus 10, when the Plant Apparatus 10 is placed upright, the thicker or wider the borders of cells of the tessellated Indentations 22 may be sealed. As an example, the lowest area of the Plant Apparatus 10 may comprise the smallest indentations with widest sealed borders therebetween, while the highest area of the Plant Apparatus 10 may comprise the largest indentations with the narrowest sealed borders therebetween. This enables to overcome the natural unequal liquid pressure in different heights and provide equal liquid supply to each area.

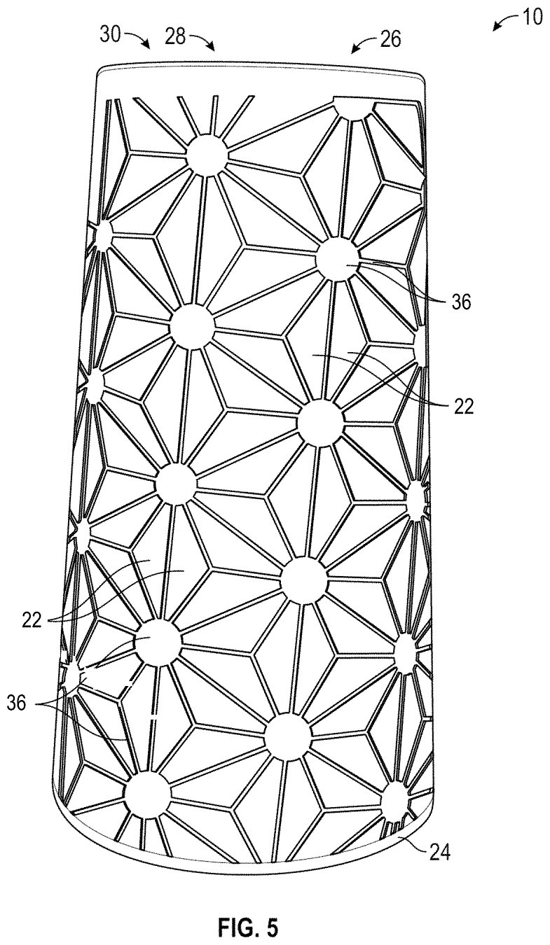

Referring now to FIG. 5, illustrating a front elevation view of a plant apparatus employing an exemplary geometric pattern, according to some embodiments of the disclosed subject matter. As illustrated in FIG. 5, the Plant Apparatus 10 may be rendered in the form of a vase. In this particular embodiment, the plurality of tessellated Indentations 22 forms an exemplary geometric pattern with Indentations 22 that are larger than the indentations illustrated in FIG. 1. The larger indentations may be suited to the growth of plants originating from larger seeds, for creating particular patterns of smaller plants growing in communities along the indentations, or the like. Sealings 36 between the Indentations 22 may be glazed, glossed, or otherwise sealed to prevent encroachment of plants growing within the Indentations 22 and to restrict plant growth, e.g., to conform to the pattern defined by the Indentations 22. Thus a living geometry may be sustained on the Exterior Surface 20.

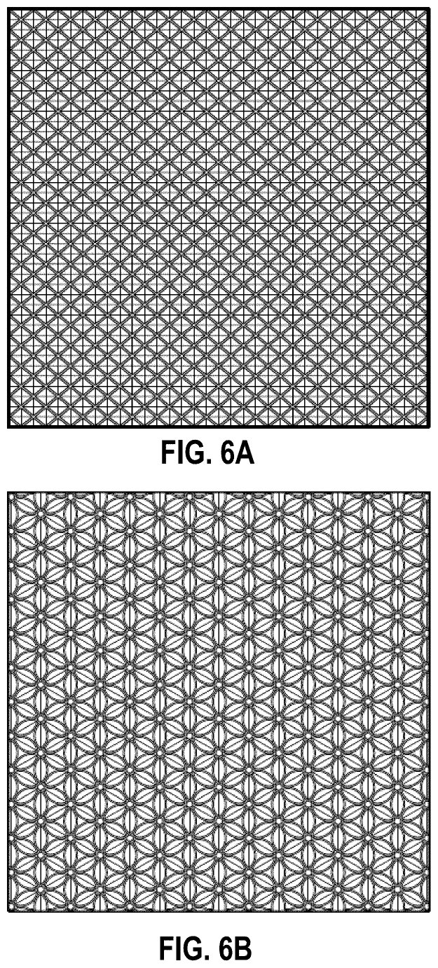

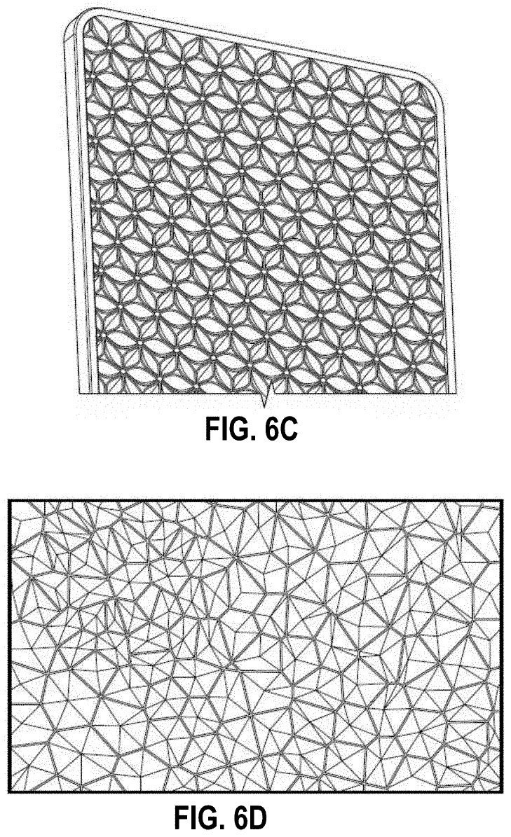

Reference is made to FIGS. 6A-6D, illustrating regular and irregular tessellated indentations, according to some embodiments of the presently disclosed subject matter. As illustrated in FIGS. 6A-6D, the tessellated indentions are formed on the Exterior Surface 20 of the Plant Apparatus 10. FIGS. 6A-6D demonstrate that additional geometric arrays, patterns, forms, or other indentations, both regular and irregular, may be contemplated as part of Plant Apparatus 10. The particular tessellated indentations as contemplated herein are set forth, therefore, not as supposed limiting features of the present invention, but in example embodiments illustrative of the many potential variations that are contemplated as within the scope of the intended claims, as apprehensible by a person of ordinary skill. In some exemplary embodiments, any alternative geometric arrays, patterns, forms, or other indentations, both regular and irregular, may be utilized.

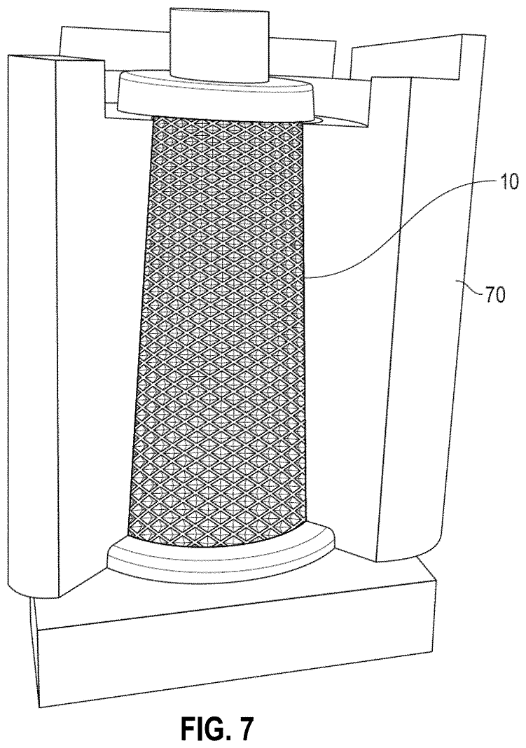

Referring now to FIG. 7, illustrating a front elevation view of a matrix slip cast interior, according to some embodiments of the presently disclosed subject matter. The matrix, e.g., Matrix 70, may include a mold for casting a plant apparatus, depicted with one side removed to show the matrix's inside. As illustrated in FIG. 7, the production of a Plant Apparatus 10 is implemented using Matrix 70. Matrix 70 supports the Plant Apparatus 10 during slip casting to form the patterns informed by the plurality of tessellated Indentations 22 over the Exterior Surface 20 previous to firing of the Plant Apparatus 10. Each Plant Apparatus 10 is thus creatable by action of an individual matrix 70 impressing into the Exterior Surface 20. The matrix 70 is thence removed previous to firing to reveal the pre-fired Plant Apparatus 10 with the desired tessellated Indentations 22 comprising at least a part of the Exterior Surface 20 of the Plant Apparatus 10.

In some exemplary embodiments, various portions of the Exterior Surface 20 such as portions not impressed by the matrix 70 may be glazed prior to firing, whereby coloration, gloss finish, and other features, may be added to the design and used to form a patterned aesthetically pleasing Plant Apparatus 10. The flora growing in the Indentations 22 may incorporate a novel, living design that corresponds to the glazing. Additionally, sealant may be brushed onto portions of the exterior surface after firing to render portions impermeable.

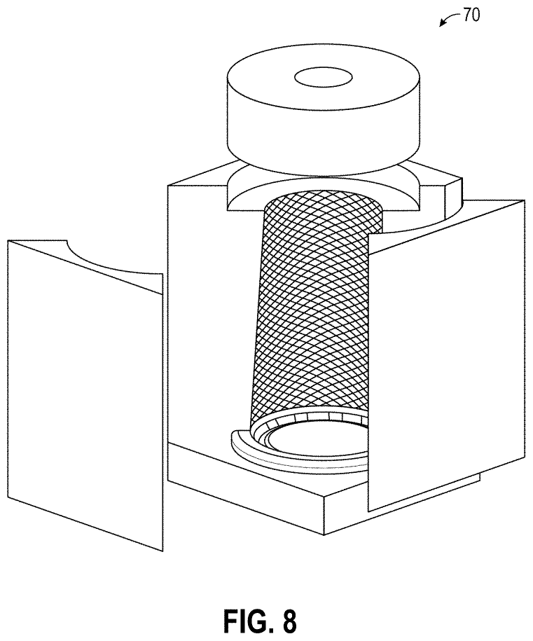

Referring now to FIG. 8, illustrating a front elevation view of an exemplary slip cast mold, e.g., matrix 70, having one side removed, according to some embodiments of the presently disclosed subject matter. As illustrated in FIG. 8, Matrix 70 is shown in absent of a Plant Apparatus 10 therein. In some exemplary embodiments, Matrix 70 may include any alternative desired size, shape, patterns, or the like, forming corresponding indentations of bulges. In some exemplary embodiments, in case a ceramic plant apparatus is desired, a Plant Apparatus 10 may be formed by slip casting, e.g., inserting liquid clay into Matrix 70 to incorporate a shape and the tessellated indentations of the Matrix 70. In some exemplary embodiments, instead of porous clay, alternative materials with similar porousness or perforated attributes may be used to generate the Plant Apparatus 10 using similar molding techniques. For example, porous polymer or plastic that can absorb liquid and let it slowly drain out may be used to form the Plant Apparatus 10 instead of clay, e.g., using Matrix 70 or any other mold. Alternative porous materials may include concrete, resin, fabric, microfiber, material that has artificially become porous, or the like.

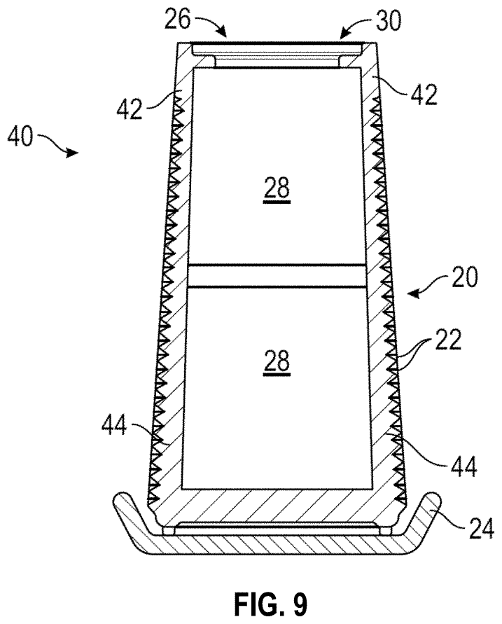

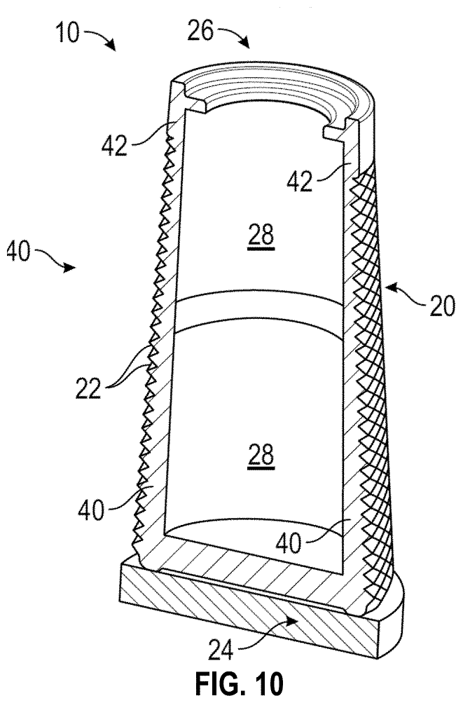

Referring now to FIGS. 9 and 10, illustrating a Plant Apparatus 10 showing a graduated cross-section between a minimum thickness, disposed most proximal the Open Top 26, and a maximum thickness disposed most proximal the lowermost edge of the Plant Apparatus 10, bounding an interior volume, according to some embodiments of the presently disclosed subject matter. In some exemplary embodiments, in case a thickness of a Plant Apparatus 10's walls is uniform, the liquid may concentrate and drain mostly in a lowermost Edge 32 of Plant Apparatus 10, e.g., in accordance with the hydrostatic pressure, creating an uneven liquid distribution that provides different amounts of liquid resources to different indentations. This phenomenon may be especially noticeable for a Plant Apparatus 10 of a capacity that overpasses three liters, or even 1.5 liters.

As illustrated in FIGS. 9 and 10, a graduated Cross-section 40 is disposed in the Plant Apparatus 10. The graduated Cross-section 40 may be applicable to all embodiments wherein a hydrostatic pressure of standing liquid forms a pressure gradient within the liquid Storage Volume 30, the Interior Volume 28, or upon the Plant Apparatus 10 regardless of the shape of the Plant Apparatus 10 in contemplation. The graduated Cross-section 40 regulates liquid flow through to the Exterior Surface 20 and thus controls the rate of liquid that is made available to flora disposed on the Exterior Surface 20, e.g., potentially equalizing the water pressure over the Plant Apparatus 10.

Graduated Cross-section 40 bounds the Interior Volume 28 from a minimum Thickness 42 most proximal the Open Top 26 (where the water pressure may be lower as there is less liquid above the top area in comparison to the bottom area) to a maximum Thickness 44 most proximal the Base member 24 (where the water pressure is naturally higher). The graduated Cross-section 40 regulates liquid flow through the Apparatus 10 from the Interior Volume 28 through to the Exterior Surface 20 to accommodate the hydrostatic pressure gradient of the liquid head exerted by the associated liquid column standing within the liquid Storage Volume 30. Greater pressure exerted at the bottom of the liquid column may be at least partially balanced by a greater distance that the liquid must travel at the lowermost Edge 32 of the liquid column through the porosity of the Apparatus 10 at the maximum Thickness 44, for example, in order to reach the Flora 102 (FIG. 2A) at the Exterior Surface 20. Similarly, the lesser pressure that is exerted by gravity and/or water pressure at the top of the liquid column that is more proximal the Open Top 26, may be at least partially balanced by the lesser distance the liquid must travel through the porosity of the Apparatus 10 at the minimum Thickness 42 in order to reach the outer Exterior Surface 20.

Thus liquid flow through the Apparatus 10, and therefore liquid availability in general, is regulated and maintained consistently across the Exterior Surface 20 as long as there is liquid occupying the liquid Storage Volume 30. Further, the graduated Cross-section 40 may match a gradation of thickness between the minimum Thickness 42 to the maximum Thickness 44, effecting the porosity and size of the Plant Apparatus 10 by properly regulating liquid flow over time. In some exemplary embodiments, as the liquid is absorbed slower in the bottom of Apparatus 10 due to Thickness 44, and faster in a top of Apparatus 10 due to Thickness 42, the liquid may be distributed more equally to all areas with Flora 102, in contrary to the hydrostatic pressure.

In some exemplary embodiments, the graduated Cross-section 40 may be produced during slip-casting process such as using Matrix 70 (FIG. 8) or any other molding technique by inserting the liquid clay to the mold at a regulated pace. In some exemplary embodiments, the mold may correspond to a shape of the graduated Cross-section 40. The resulting pre-fired workpiece may be graduated at a continuous rate of change determined by the flow rate of the slip-cast draining through a lowermost aperture. In some exemplary embodiments, the clay liquid may be placed for longer periods of time at locations that are intended to be thick, and shorter periods of time at locations that are intended to be thin.

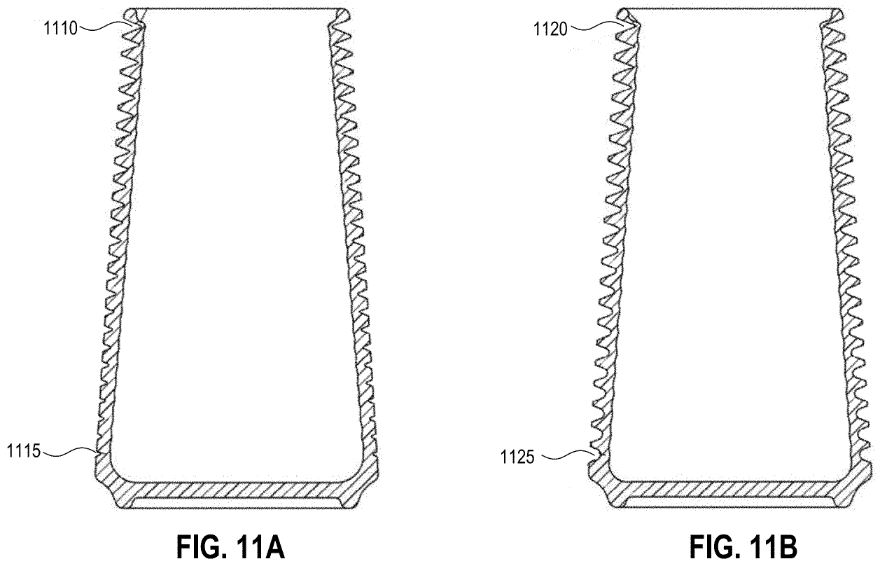

Reference is made to FIGS. 11A-11B, illustrating a longitudinal cross-section of a Plant Apparatus 10 showing gradual differences in size, depth, and shape of its grooves. In some exemplary embodiments, since molding gradually-thickening walls of an apparatus with identical Indentations 22, such as the graduated Cross-section 40 depicted in FIG. 10, may be complex and time consuming, non-identical Indentations 22 may be used to provide walls with a gradually increasing depth (from top to bottom). In some exemplary embodiments, non-identical Indentations 22 such as the indentations of FIGS. 11A-11B may be manufactured in a production process that is fast and simple, without compromising on the advantages of the gradually-thickening walls in FIG. 10.

FIG. 11A illustrates a Plant Apparatus 10 with altering sized slots or Indentations 22 (FIG. 1A) with different depths and dimensions. In some exemplary embodiments, the different sized slots may be large and deep atop and small and shallow at the bottom, causing the walls to be thinner atop and thicker at the bottom. The liquid may be enabled to seep swiftly through the top thin wall, which may be thin due to the large and deep slots. In some exemplary embodiments, in some cases, the slots may have large dimensions atop and small dimensions at the bottom while having a same depth, may have shallow slots atop and deep slots at the bottom while having a same diameter, or any other combination of size, depth and shape. In some exemplary embodiments, the topmost Slot 1110 may be a deepest and biggest slot type, causing the wall to be the thinnest and the liquid to seep the fastest, e.g., thereby balancing the hydrostatic pressure. In some exemplary embodiments, the bottom Slot 1115 may be a shallowest and smallest slot type in the wall, causing the bottom side wall of the body to be the thickest and the liquid to seep out slowest, thereby enabling to balance the hydrostatic pressure. In some exemplary embodiments, Slots 1110 and 1115 may have a same shape with different depth and size. In some exemplary embodiments, the wall may gradually alter or decrease in size from the top big slot size to the small slot size at the lowermost Edge 32, e.g., linearly. In some exemplary embodiments, the different thickness of the walls, obtained via different groove shapes, may contrast with the hydrostatic pressure, and ensure that the liquid is provided more equally to all indentations.

FIG. 11B illustrates a Plant Apparatus 10 with altering shaped slots or Indentations 22 (FIG. 1A) having an altering depth and a same diameter. In some exemplary embodiments, the different shaped slots are spikier and deeper atop while being rounder and shallow at the bottom, causing the walls to be thinner atop and thicker at the bottom as the round shape utilizes less space. In some exemplary embodiments, the topmost Slot 1120 has a shape that is most sharp and deep, causing the wall to be the thinnest and the liquid to seep out fastest, e.g., thereby balancing the hydrostatic pressure. In some exemplary embodiments, the bottom Slot 1125 has a shape that is roundest and most shallow, causing the bottom wall to be the thickest and the liquid to seep out slowest, e.g., thereby balancing the hydrostatic pressure. In some exemplary embodiments, the wall may gradually alter from the top spiky deep Shape 1120 to the rounded shallow Shape 1125 at the bottom, e.g., linearly. In some exemplary embodiments, any other combination of shapes, sizes and depths may be used to provide an altering thickness to the walls. In some exemplary embodiments, the different thickness of the walls, obtained via different groove shapes, may contrast with the hydrostatic pressure, and ensure that the liquid is provided more equally to the accessible indentations.

In some exemplary embodiments, basing the depth of the walls on slot sizes, depths, or shapes may enhance a molding process. In some exemplary embodiments, a mold for slip casting a Plant Apparatus 10 may include patterns configured to form corresponding indentations in inserted liquid clay that is configured to become the Plant Apparatus 10. In some exemplary embodiments, the mold's patterns may be used to form the desired depth gradient in the walls of the Plant Apparatus 10. In some exemplary embodiments, the patterns may be configured to form a graduated depth of the exterior surface that gradually increases a depth from a top of the exterior surface, when placed upright, to a bottom of the exterior surface.

In some exemplary embodiments, the mold may include a selected shape, depth, or size that is altered from top to bottom. For example, the portion of the mold associated with a top portion of the future plant apparatus may comprise large sized slots, while the portion of the mold associated with a bottom side portion of the future plant apparatus may comprise small sized slots, e.g., similarly to FIG. 11A. As another example, the portion of the mold associated with a top portion of the future plant apparatus may comprise deep sharp slots, while the portion of the mold associated with a bottom side portion of the future plant apparatus may comprise shallow round slots, e.g., similarly to FIG. 11B. In some exemplary embodiments, the setting of the slot shapes, depths, and sizes may comprise any other combination ensuring that the depth of the walls gradually becomes thinner as the height of the plant apparatus, when placed upright, increases.

In some exemplary embodiments, the patterns of the mold may be configured to form gradually altering indentation shapes or sizes in the inserted liquid clay, wherein the slip casting is performed for a unified timeframe for the different height gradients. In some exemplary embodiments, the slip casting process may comprise inserting a nozzle into the mold, e.g., to a bottom portion thereof or any other mold area, and releasing the liquid slip material at a consistent rate for a predetermined timeframe. In some exemplary embodiments, the liquid slip material may be flowed into the mold, e.g., in a slow rate, or in any other speed. In some exemplary embodiments, since the ceramic liquid is inserted into the mold for a unified time, the resulting apparatus may have a thickness gradient that is thinner at top and thicker at bottom according to the geometric shapes of the mold, e.g., based on the geometric difference of the slot shapes of the mold. In some exemplary embodiments, enabling slip casting with a unified timeframe and a consistent releasing rate, for all portions or height gradients of the exterior surface, may be advantageous over inserting ceramic liquid to mold areas for different amounts of time for each height gradient, e.g., as may be performed for obtaining the plant apparatus of FIG. 9 or 10. In some exemplary embodiments, the plant apparatus of FIG. 9 or 10 may be generated by leaving the ceramic liquid for longer timeframes at areas corresponding to thick bottom side portions, and leaving the ceramic liquid for shorter time periods for the thin top ceramic portions, e.g., gradually. This process may be time consuming and challenging compared to leaving the ceramic liquid for a unified same amount of time for all portions, e.g., when utilizing the different geometric shapes of the slots.

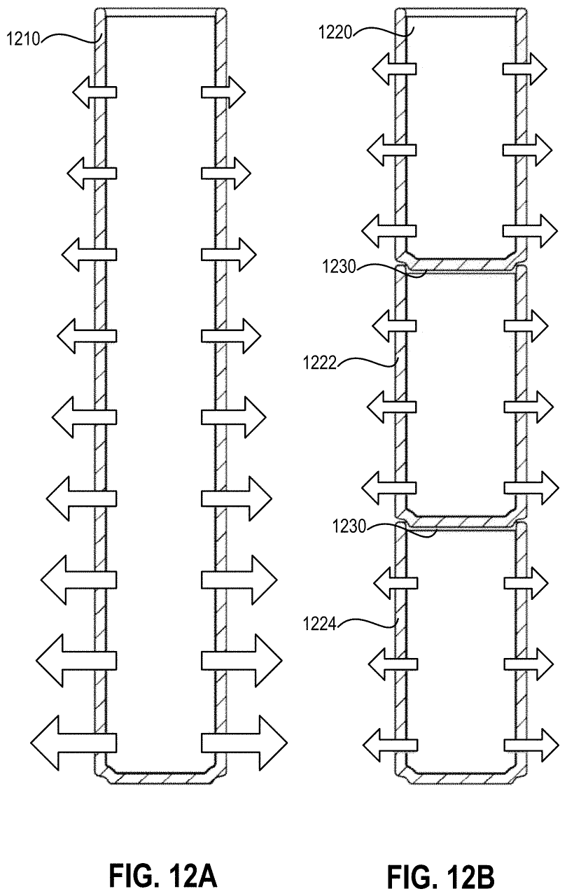

Reference is made to FIGS. 12A-12B, illustrating longitudinal cross-sections of plant apparatus configurations, e.g., influencing the liquid pressures in the corresponding configurations. In some exemplary embodiments, the size of the depicted arrows may correspond to a relative hydrostatic pressure that is placed on the walls.

FIG. 12A illustrates a single Plant Apparatus 1210 with large dimensions, e.g., compared to dimensions of the modular plant apparatuses in FIG. 12B. As illustrated in FIG. 12A, the hydrostatic pressure is mild on a top portion of the Plant Apparatus 1210, but gets gradually more severe at the bottom, as the portion is lower (denoted by the size of the arrows). It may be desired to prevent the hydrostatic pressure from increasing to a level of the lowermost Edge 32 portion of Plant Apparatus 1210.

FIG. 12B illustrates an assembly of integrated plant apparatuses, forming a uniformed appearance. In some exemplary embodiments, in order to balance the liquid pressure and avoid from exerting an extremely high hydrostatic pressure on the walls, a modular apparatus comprising a number of small-capacity plant apparatuses such as Apparatuses 1220, 1222, and 1224 may be used. In some exemplary embodiments, the modular apparatus may be created by assembling Apparatuses 1220, 1222, and 1224, joining them, combining them, placing them on top of each other, or the like, instead of using a single large-capacity plant apparatus such as Apparatus 1210. In some exemplary embodiments, the assembly may enable disassembling for irrigation purposes, maintenance purposes, or the like.

In some exemplary embodiments, as illustrated in FIG. 12B, Plant Apparatus 1220 is placed above Plant Apparatus 1222, which is placed right above Plant Apparatus 1224. In some exemplary embodiments, the plant apparatuses may comprise a strongly sealed lowermost Edge 32 that prevents any liquid drain. In some exemplary embodiments, in order to create a uniformed look and hide the fact that the assembly is a modular assembly comprising Plant Apparatus 1220, Plant Apparatus 1222, and Plant Apparatus 1224, each small-capacity plant apparatus may include a low bulge 1230 that may be placed in a top opening of the next plant apparatus. Specifically, the lowermost Edge 32 of the Plant Apparatus 1220 may comprise a low Bulge 1230 at bottom that can be inserted in an opening of Plant Apparatus 1222, and the lowermost Edge 32 of Plant Apparatus 1222 may comprise a low Bulge 1230 at bottom that can be inserted in an opening of Plant Apparatus 1224, thereby creating a uniformed look without liquid transferring between the plant apparatuses.

In some exemplary embodiments, placing the small-capacity plant apparatuses on top of each other with a certain spacing between them, without a space between them, or the like, provides a uniformed look of one large vase while reducing the maximal liquid pressure in each small-capacity apparatus to be relative to the size of each small-capacity apparatus. In some exemplary embodiments, the hydrostatic pressure is initialized by each plant apparatus, providing a mild pressure on a top of each plant apparatus with continuously and gradually increasing pressure on the remaining portions. In some exemplary embodiments, by limiting the size of Apparatus 1210 to a third, or to any other percentage or size, the hydrostatic pressure on each separate apparatus may be limited to the top portion of Apparatus 1210 corresponding to the size of the small-capacity apparatus, which is the lowest pressure area of Apparatus 1210. In some exemplary embodiments, as illustrated in FIG. 12B, the hydrostatic pressure exerted on Apparatuses 1220, 1222, and 1224, as depicted by the arrows of each of Apparatuses 1220, 1222, and 1224, corresponds to the hydrostatic pressure exerted on the top third of Apparatus 1210, which corresponds in length to each of Apparatuses 1220, 1222, and 1224.

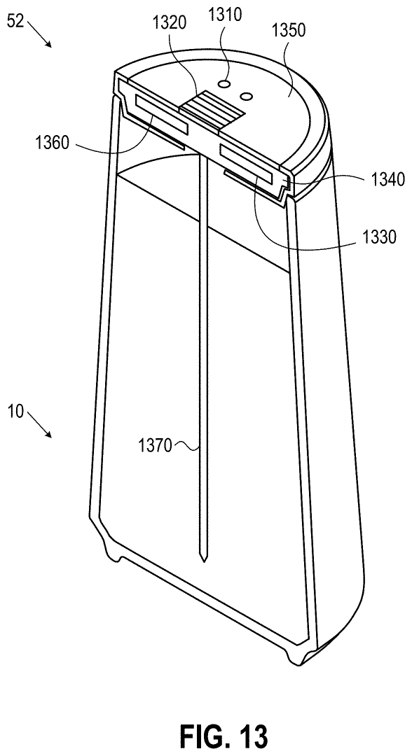

Reference is made to FIG. 13, illustrating a longitudinal cross-section of a Plant Apparatus 10 (FIG. 1A) with a Lid member 52. In some exemplary embodiments, the Plant Apparatus 10 may include a functional sealed Lid member 52, cover, top or the like, that is configured to seal a top opening of the plant apparatus and prevent entrance of bugs, mosquitos, pests, germs, dust, or the like, into the liquid retained by Plant Apparatus 10. In some exemplary embodiments, the plant apparatus may include, in addition to Lid member 52, a hollow body enabling to retain liquid and a Base member 24 (FIG. 1B) configured to accumulate excess liquid from the body, e.g., from Indentations 22.

In some exemplary embodiments, the Lid member 52 may comprise one or more sensors configured to measure the liquid level of Plant Apparatus 10, a liquid amount in Plant Apparatus 10, an amount of light reaching the Plant Apparatus 10, an amount of light reaching an environment of Plant Apparatus 10, or the like. In some exemplary embodiments, the Lid member 52 may comprise an internal liquid level sensor configured to measure a liquid level within the internal volume. In some exemplary embodiments, an exterior surface of the Lid member 52 may comprise a light sensor configured to measure an exposure level of the lid member to light. Alternatively, the internal liquid level sensor may be placed or coupled to any other component or area of plant apparatus, and the light sensor may be placed or coupled to any other external surface of plant apparatus.

In some exemplary embodiments, the sensor information such as the liquid level and the exposure level may be signaled to a user via a signaling mechanism, e.g., wireless communication, a buoy, a side pipe, indication lights, or the like. In some exemplary embodiments, the sensor information may be provided directly to the user via wireless communication such as WIFI™ or BLUETOOTH™ Component 1360, or via a visual user interface such as Indicator Lights 1310. In some exemplary embodiments, Lid member 52 may comprise Indicator Lights 1310 or any other indication medium configured to indicate to the user the current lighting situation and liquid level. For example, a first light may indicate the liquid level using different lights for different liquid levels (e.g., red indicating a low liquid level and green indicating an acceptable liquid level), different patterns of turning on and off (e.g., e.g., flickering indicating a low liquid level and a stable light indicating an acceptable liquid level), or the like, while a second light may indicate the lighting exposure level using the same signal conveying method as the first light, or an alternative method such as using different lights for different lighting levels, different patterns, or the like. Alternatively, a single indicator light may be used for both liquid and lighting level indication. For example, a single light may flicker in red when a lighting level is insufficient, flicker in green when the liquid level is insufficient, and in case both are insufficient, the color of the flickering light may continuously move from green to red and vice versa. Alternatively, a separate indicator light may be used for every level of indication of every sensor. For example, a first light may be configured to indicate that the a lighting level is insufficient, a second light different from the first light may be configured to indicate that the a lighting level is sufficient, or the like.

In some exemplary embodiments, the sensors of Lid member 52 may utilize power resources, e.g., solar or battery power. In some exemplary embodiments, Lid member 52 may comprise a Solar Panel 1320, Battery 1330, or any other energy medium enabling to provide power resources to one or more sensors of the lid. For example, Solar Panel 1320 may provide energy to Indicator Lights 1310, while Battery 1330 may provide energy for Lighting Sensor 1350 and Liquid Level Sensor 1370, or vice versa. Alternatively, Battery 1330 or Solar Panel 1320 may provide energy for all the sensors of Lid member 52.

In some exemplary embodiments, the light exposure, which may be a crucial parameter for growth of the corresponding Flora 102 (FIG. 2A), may be measured on the outer surface of the plant apparatus or cover thereof, while the liquid level may be measured within the body of the Plant Apparatus 10. In some exemplary embodiments, the Lighting Sensor 1350 may be located at an external top part of the lid, as illustrated in FIG. 13, or in any other available location that is exposed to the light. In some exemplary embodiments, the Liquid Level Sensor 1370 may be located at an internal part of the body, e.g., starting at the lid atop and reaching the internal area of the body, so as to have access to the actual liquid level, as illustrated in FIG. 13. In some exemplary embodiments, Printed Circuit Board (PCB) Component 1340 may be used to control the sensor data, the functionality of the lid, the communication of the data, the user interface, or the like.

In some exemplary embodiments, the sensors may be integrated as part of Lid member 52, as part of the body, as part of Base member 24, a combination thereof, or the like. In some exemplary embodiments, utilizing the Lid member 52 for measuring the liquid level and light exposure may be advantageous, e.g., since the Lid member 52 has access to the internal liquid from its internal side, and access to the external surface from its external side, since it may not harm or affect an esthetic design of the Apparatus 10, or the like.

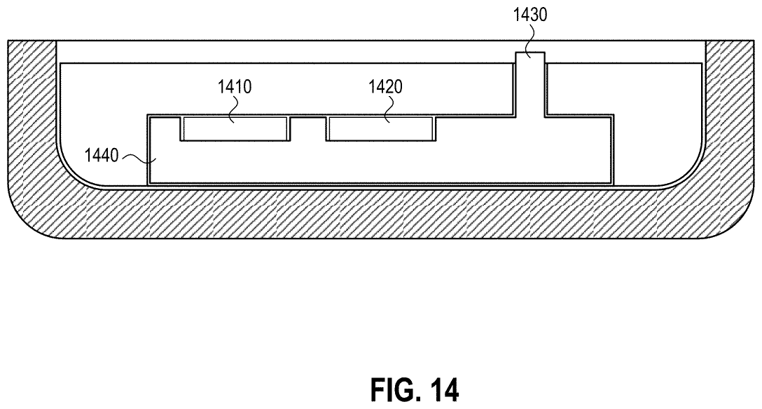

Reference is made to FIG. 14, illustrating a cross-section of a Base member 24 of a Plant Apparatus 10 (FIG. 1B), in a form of a vase, a tile, or the like. In some exemplary embodiments, Base member 24 may be disposed basally supporting a body of the Plant Apparatus 10. In some exemplary embodiments, Base member 24 may be configured to accumulate excess liquid from the Plant Apparatus 10, e.g., draining from Indentations 22 (FIG. 2A), from a top opening, from a porous lowermost Edge 32, or the like. In some exemplary embodiments, it may not be desired to retain standing liquid in the Base member 24 for long periods of time, e.g., a day, a week, a month, or the like, as this may harm the Base member 24, attract pests, cause the area to become septic, or the like. In some cases, even if a net is placed between the body of Plant Apparatus 10 and Base member 24, Base member 24 may still be prone to germs or pests since Base member 24 is exposed to the environment.

In some exemplary embodiments, Base member 24 may comprise one or more Evaporating Components 1410 configured to evaporate excess liquid, e.g., a humidifier or an ultrasonic transducer configured to evaporate excess liquid from the Base member 24. In some exemplary embodiments, the Evaporating Components 1410 may be configured to evaporate the liquid so that users may not be required to empty the liquid themselves, to clean Base member 24, or the like, in order to enhance the user experience, in order to provide humidity to the Flora 102 (FIG. 2A), or the like. In some exemplary embodiments, Evaporating Components 1410 may be configured to direct the generated vapor to a direction of the flora, e.g., in order to be absorbed by the flora and saturate the flora.

In some exemplary embodiments, based on an identified liquid level, the evaporation process may be activated, initiated, deactivated, terminated, or the like. For example, in case the liquid level is above a threshold, the evaporation process may be activated to evaporate excess liquid until the liquid level reaches a desired level, e.g., in the direction of the flora. In some exemplary embodiments, the evaporation process may be triggered upon identifying that a time threshold has passed, that a liquid level is above a threshold, or a combination thereof. For example, upon identifying that the Base member 24 has a liquid level above half of the capacity of Base member 24 for more than 20 minutes, the process may be initiated. In some exemplary embodiments, the evaporation process may be triggered by the liquid itself, which may be used to close a circuit and activate the Evaporating Components 1410. In some exemplary embodiments, the evaporation process may be triggered using any other means, such as using electronic signals, manually, or the like.

In some exemplary embodiments, the Evaporating Components 1410 of Base member 24 may include a humidifier, an ultrasonic speaker, an audio laser directing sound to specific laser point, or the like, which may cause a ceramic disc to vibrate and evaporate the liquid thereby. In some exemplary embodiments, the Evaporating Components 1410 of Base member 24 may include a chemical material that may be configured to evaporate liquid using chemical reactions. In some exemplary embodiments, Base member 24 may include a Liquid Level Sensor 1430 configured to measure a liquid level within Base member 24, within Plant Apparatus 10, or the like. In some exemplary embodiments, Base member 24 may include a power source such as a Battery 1420, a PCB component 1440, or the like.

In some exemplary embodiments, the Base member 24 may be implemented as a base member of one or more vases, a base member of one or more tiles, a gutter of one or more tiles, or the like. In some exemplary embodiments, the Base member 24 may be placed below Plant Apparatus 10, around Plant Apparatus 10, or the like, where it has access to excess liquid reservoir, so that it could evaporate liquid and generate humidity in the air. In some exemplary embodiments, creating humidity from excess liquid may be advantageous as it removes undesired excess liquid retained in Base member 24, while simultaneously providing humidity to the plants.

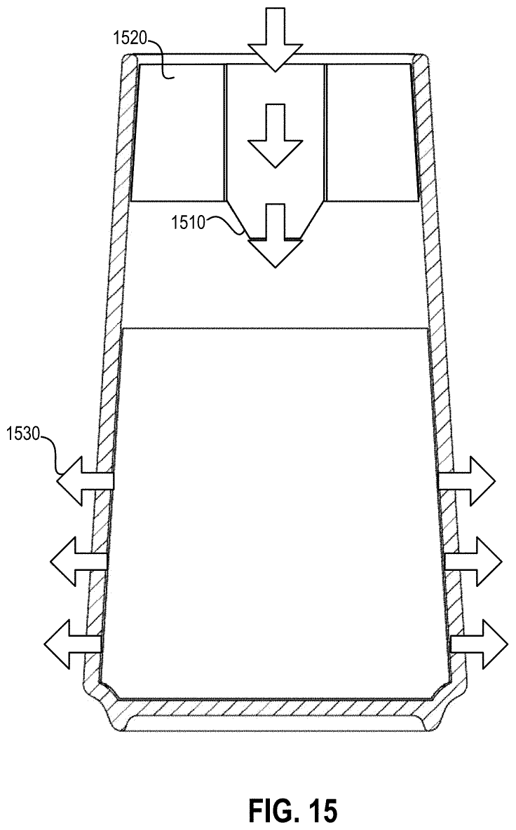

Reference is made to FIG. 15, illustrating a longitudinal cross-section of a Plant Apparatus 10 (FIG. 1A) with water pressure control. In some exemplary embodiments, the Lid member 52, Base member 24, body, or any other portion of Plant Apparatus 10 (FIG. 1B), may comprise or integrate one or more internal air pumps and one or more internal air compressors configured to control an air pressure within the Plant Apparatus 10, thereby influencing a rate of liquid flow from the Internal Volume 30 to the Exterior Surface 20, from the Exterior Surface 20 to the Internal Volume 30, or the like.

In some exemplary embodiments, Plant Apparatus 10 may comprise an Air Compressor 1520, an Air Nipple 1510, or the like, configured to control the liquid pressure in the Plant Apparatus 10, thereby enabling to control the irrigation frequency and effectiveness. In some exemplary embodiments, the Air Nipple 1510 may comprise at least one pump such as a simple pump similar in structure to a bicycle pump, or any other pump type, configured to transfer air pressure between Air Compressor 1520 and the internal air of Plant Apparatus 10. In some exemplary embodiments, the Air Nipple 1510 may be configured to insert Air Pressure 1530 generated by the Air Compressor 1520 in the body of the Plant Apparatus 10 or extract air pressure out of the Plant Apparatus 10 and into the Air Compressor 1520.

In some exemplary embodiments, increased air pressure within the Plant Apparatus 10 may increase a rate the liquid passage from the body to the external Indentations 22, while reducing air pressure within the Plant Apparatus 10 may decrease a rate the liquid passage from the Internal Volume 30 to the external Indentations 22. In some exemplary embodiments, reducing the air pressure such as by pumping out air from the Plant Apparatus 10, may cause liquid to seep out slower, or even to return excess liquid from the Indentations 22 to the internal volume. In some exemplary embodiments, it may be desired to insert liquid from the exterior surface to the Internal Volume 30 in case of excess liquid, e.g., in case of rain, in order to assist in creating a wet-dry-wet cycle, which may be healthy for the corresponding Flora 102, or the like.

In some exemplary embodiments, the Air Compressor 1520, the Air Nipple 1510, or the like, may be placed in the internal space of the Plant Apparatus 10. In some exemplary embodiments, in some cases, multiple pumps may be used to generate different air pressure in different areas or heights of the plant apparatus. For example, a high air pressure at a top portion of Plant Apparatus 10 may cause the liquid to seep out swiftly at the top wall portion of the body, and a reduced air pressure at a bottom wall portion of the body of Plant Apparatus 10 may cause the liquid to simultaneously seep out slowly in the bottom wall portion, thus enabling to overcome the natural pressure differences.

In some exemplary embodiments, one or more top air pumps and one or more bottom air pumps may be placed within Plant Apparatus 10. In some exemplary embodiments, a top air pump and a bottom air pump may be placed in different height gradients within Plant Apparatus 10, e.g., the top air pump being placed higher than the bottom air pump. In some exemplary embodiments, the top and bottom air pumps may be configured to control an air pressure within Plant Apparatus 10, thereby influencing a rate of liquid flow from Internal Volume 30 to the Exterior Surface 20. In some exemplary embodiments, the top air pump may be configured to increase the air pressure, e.g., thereby increasing a seeping rate in the top portion, and the bottom air pump may be configured to decrease the air pressure, e.g., thereby decreasing a seeping rate in the bottom wall portion of the body.

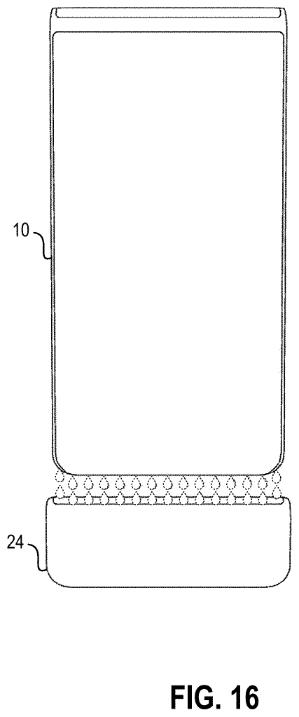

Reference is made to FIG. 16, illustrating a front elevation view of a tile implementation of Plant Apparatus 10 and a corresponding base member. In some exemplary embodiments, the tile may include a potentially independent ceramic tile for hanging on a vertical surface such as a wall. In some exemplary embodiments, the tile may enable plant growth on a front porous side, while the back side facing the vertical surface is sealed to prevent moisture in the surrounding environment. In some exemplary embodiments, alternatively, the tile may include a non-hangable ceramic tile such as an independent tile holding itself, that is not attached to a wall, that is placed near a wall, that is placed on a horizontal surface, or the like. In some exemplary embodiments, the tile may include a body and a Base member 24 for accumulating excess liquid from body, e.g., dripping out from the Exterior Surface 20, from a porous lowermost Edge 32 of Plant Apparatus 10, or the like. In some exemplary embodiments, B ase member 24 may be configured to be coupled to the plant apparatus, e.g., mechanically, in order to accumulate excess liquid from the Plant Apparatus 10. In some exemplary embodiments, as illustrated in FIG. 16, Base member 24 may be configured to be placed below the Plant Apparatus 10, e.g., with or without a space therebetween, in a location that enables to accumulate excess liquid from the Plant Apparatus 10.

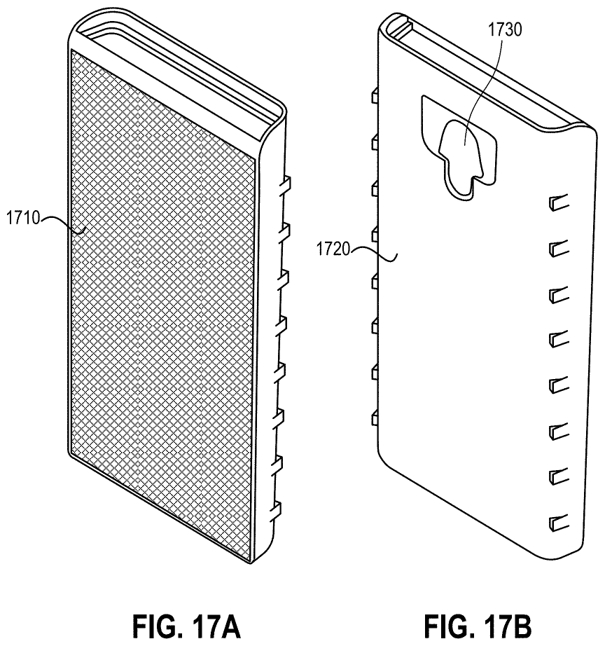

Reference is made to FIGS. 17A-17B, illustrating a raised elevation view of an external front surface and a back surface of Plant Apparatus 10 (FIG. 1A) implemented as a hangable tile. As illustrated in FIG. 17A, the Front Face 1710 of the tile which faces the room includes a porous material enabling liquid to seep out the tile to enable plant growth. In some exemplary embodiments, the Front Face 1710 may be fully porous, partially sealed such as in order to equalize a liquid pressure, have alternative indentation shapes, sizes, or depths, or the like. As illustrated in FIG. 17B, the Back Face 1720 of the tile, which faces the vertical wall, may be sealed with a sealing material such as a glaze, a gloss, or any material that prevents the liquid from seeping out from the internal volume to the vertical surface, that prevents floral growth, that prevents anchoring of floral, or the like. In some cases, the Back Face 1720 of the tile may comprise non-porous material, making the glazing phase redundant. In such a scenario, the Front Face 1710 and the Back Face 1720 may be created separately from different materials, and then adhered together using an adhering material such as glue. In some exemplary embodiments, the Back Face 1720 of the tile may be attached to the vertical surface, e.g., via Interface 1730, which may be coupled to a corresponding bulge, a hook, or any other attaching technique.

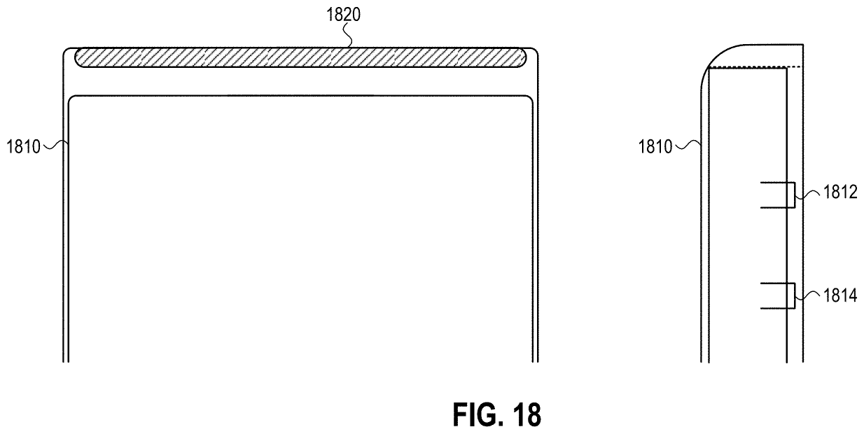

Reference is made to FIG. 18, illustrating a front view and a side view of a tile implementation of Plant Apparatus 1810. In some exemplary embodiments, a back face of Plant Apparatus 1810 may be composed of small extrusions or hooks such as Extrusions 1812 and 1814. In some exemplary embodiments, Extrusions 1812 and 1814 may be designed for inserting therein a binding or adhering material such as a string, a wire, a rubber band, or the like, to enable to adhere Plant Apparatus 1810 to a vertical surface behind the Plant Apparatus 1810, to enable to adhere the Plant Apparatus 1810 to one or more neighboring tiles, or the like. In some exemplary embodiments, Extrusions 1812 and 1814 may enhance the utility of Plant Apparatus 1810 and enhance the user interface and ease of use of Plant Apparatus 1810. In some exemplary embodiments, upon being overflowed, the liquid within Plant Apparatus 1810 may drip from Plant Apparatus 1810, e.g., to a Base member 24 (FIG. 1B), to a tile or vase of an assembly placed blow Plant Apparatus 1810, or the like. In some exemplary embodiments, overflowed liquid may drip out from various locations of Plant Apparatus 1810, such as from the Indentations 22, from a porous lowermost Edge 32 portion of Plant Apparatus 1810, from a top of Plant Apparatus 1810, or the like. In some exemplary embodiments, the term “overflow” with respect to a plant apparatus may refer to excess water seeping through any area of the plant apparatus such as the top opening, the exterior indentations, or the like. Such excess water may be making its way down the apparatus such as to its base member, drip below the base member, or the like.

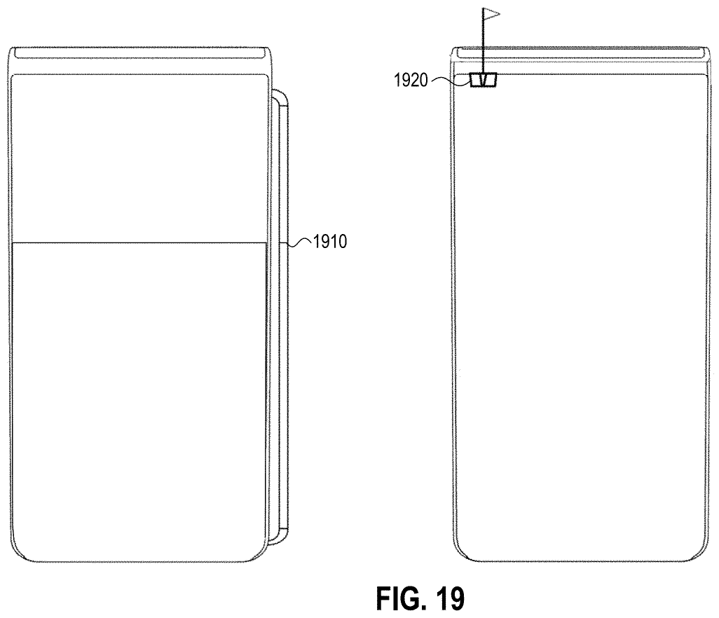

Reference is made to FIG. 19, illustrating a front view of water level detectors for a Plant Apparatus 10 (FIG. 1A) implemented as a tile. In some exemplary embodiments, it may be desired that a user will be presented with a current a liquid level of a non-transparent tile that may or may not be hangable. In some exemplary embodiments, as the plant apparatus may not be transparent, and may be coupled to a vertical surface such as a wall, potentially making the tile unreachable, high, difficult to handle, or the like, it may difficult to perceive the current liquid level.

In some exemplary embodiments, a signaling mechanism comprising one or more components of Plant Apparatus 10 may be used to automatically signal to the user the current liquid level in the tile, the light exposure level, or the like. In some exemplary embodiments, the signaling mechanism may comprise a buoy, a side pipe, indication lights, direct communication, or the like. In some exemplary embodiments, Plant Apparatus 10 may comprise a liquid meter configured to indicate a liquid level of the Internal Volume 30, e.g., a transparent side pipe that is parallel to a longitude axis the plant apparatus and has fluid communication with the internal volume, a buoy configured to float above the liquid level, or the like.

In some exemplary embodiments, the liquid meter may include a transparent Side Pipe 1910 with or without an oil bubble representing the liquid level inside the plant apparatus, e.g., based on isotropic behavior of the liquid that equalizes over different connected structures. As the liquid may have access to Side Pipe 1910, the liquid level in Side Pipe 1910 may correspond to the liquid level within the Plant Apparatus 10. In some exemplary embodiments, the liquid level may be identified based on the liquid level perceived in Side Pipe 1910, based on an oil bubble in Side Pipe 1910 that emphasizes the liquid level, based on a floating component in Side Pipe 1910 that emphasizes the liquid level, or the like. In some exemplary embodiments, the Side Pipe 1910 may be composed of any transparent or semi-transparent material such as plastic, glass, or the like.

In some exemplary embodiments, the liquid meter may include a Buoy 1920 floating on the liquid, which may inform the user whether the tile is full or not, e.g., based on whether or not a flag or bulge attached to Buoy 1920 is visible above a top opening of Apparatus 10. Additionally or alternatively, a liquid meter may comprise any alternative measuring component such as an electronic sensor (not illustrated) for identifying the liquid level.

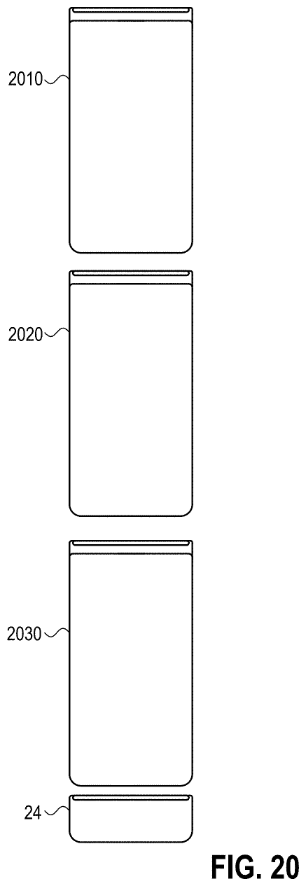

Reference is made to FIG. 20, illustrating a schematic front view of a tile assembly configuration. In some exemplary embodiments, tiles may be used as an independent unit or as part of a modular structure assembling a plurality of tiles according to a desired modular configuration, pattern, or the like. In some exemplary embodiments, the tiles may be assembled together in a configuration that resembles roof tiles, e.g., by coupling tiles to tiles placed below them, or to any other configuration that enables the tiles to feed one another. For example, a configuration resembling roof tiles may be achieved by inserting a bottom bulge of each tile to an opening of a tile beneath it. In some cases, in order to create a unified look, each top tile may comprise a bottom bulge that is inserted to a lower tile, and so on. In some exemplary embodiments, in such cases, the tiles may have no space between them and may appear as a unified structure. Alternatively, a space may separate between tiles of different heights.

In some exemplary embodiments, when assembling together a number of tiles, the irrigation of at least a portion of the assembly system may be performed jointly, such as by directing the excess liquid flow from one tile to the next, e.g., by overflowing the liquid via a top of each tile as described with respect to FIG. 18, via the porous Exterior Surface 20 of each tile (e.g., Front Face 1710 of FIG. 17A), via a porous lowermost Edge 32 of each tile, or the like. In some exemplary embodiments, excess liquid may flow between the tiles through porous portions, through indentations, slots, holes, via an overflow, or the like, to the internal volume of the next tile, the base member of the next tile, or the like. In some exemplary embodiments, an irrigation of the tile assembly may be performed separately, e.g., independently to each tile. For example, each tile may be attached to a separate irrigation pipe, each tile may be manually filled with liquid separately, or the like. In some exemplary embodiments, in some cases, some tiles of an assembly may be jointly irrigated, while others may be separately irrigated.

In some exemplary embodiments, in case a system of tiles is configured to be attached to a vertical surface such as a wall, the tiles may comprise a sealed back that inhibits plant growth in the back wall. In some exemplary embodiments, one or more tiles of the assembly may be open-topped, enabling liquid from above to enter the Internal Volume 30 of each tile. In some exemplary embodiments, one or more top tiles that are coupled to the vertical surface may be placed above one or more lower tiles, and may enable excess liquid to be directed to the internal volume of the lower tiles, e.g., upon receiving liquid at the top tiles. In some exemplary embodiments, liquid may be provided to the top tiles manually, via an automatic irrigation system such as utilizing irrigation pipes, or the like.

In some exemplary embodiments, as illustrated in FIG. 20, a top Tile 2010 may be placed above Tile 2020, which in turn may be placed above Tile 2030. In some exemplary embodiments, a sealed Base member 24 may be placed below the tile assembly, to accumulate any excess liquids. In some exemplary embodiments, a space may be retained between Plant Apparatus 2010 and Plant Apparatus 2020, as illustrated in FIG. 20. Alternatively, no space may be retained, e.g., using bottom bulges to couple the tiles. In some exemplary embodiments, in case of joint irrigation, excess liquid may flow down from Tile 2010 to Tile 2020 and to Tile 2030. In some exemplary embodiments, excess liquid may overflow from a top portion of a tile to the next tile or to the Base member 24, may travel from a porous lowermost Edge 32 of a tile to the next tile or to the Base member 24, may travel from the porous Exterior Surface 20 to the next tile or to the Base member 24, or the like. In some exemplary embodiments, the tile assembly may include any alternative number of tiles in addition to or instead of Tiles 2010, 2020, or 2030, e.g., according to a user preference, an available space, or the like, which may be suspended in any desired configuration.

In some exemplary embodiments, in contrary to living walls systems, which require a complex and costly installation, installation of the tile assembly disclosed by the current subject matter may be simple, easy, inexpensive, utilized reduced resources, or the like. Specifically, the tile assembly disclosed by the current subject matter does not utilize components that are typically required for living walls systems, such as furring strips or aluminum rails, and are simply attached to the wall. In some exemplary embodiments, the tiles may be adhered to the wall using any desired attaching medium such as screws, sticking tape, glue, or the like. In some exemplary embodiments, the current subject matter enables installation by merely attaching or adhering the tiles to the wall, using a desired irrigation source member such as a pipe which may be adhered to the wall as well and enabling to share a base member between members of a tile assembly.

In some exemplary embodiments, the tile assembly or system may comprise tiles with unified or different porousness levels. In some exemplary embodiments, a porousness level of tiles may be customized to a match desired plant type. In some exemplary embodiments, various porousness levels may be used for corresponding plant types. For example, in case an assembly of tiles, vases, or the like, is configured for a plant type with low liquid utilization, the tiles may comprise low-porousness tiles, thick-walled tiles, or the like. As another example, a set of tiles may comprise a first group of tiles that is configured to be utilized for a first type of plant associated with a first irrigation requirement, e.g., high liquid utilization, a second group of tiles that is configured to be utilized for a second type of plant associated with a second irrigation requirement, e.g., low liquid utilization, or the like. In some exemplary embodiments, the first group of tiles may comprise a first porousness level that matches the first irrigation requirement, and the second group of tiles may comprise a second porousness level that matches the second irrigation requirement. In some exemplary embodiments, in case the first irrigation requirement comprises low irrigation requirement, the first group of tiles may comprise tiles made from low-porousness material, thick-walled tiles, partially sealed tiles, or the like. In some exemplary embodiments, in case the second irrigation requirement comprises high irrigation requirement, the second group of tiles may comprise tiles made from high-porousness material, thin-walled tiles, non-sealed tiles, low sealed tile, or the like.

In some exemplary embodiments, an irrigation setting for a set of plant apparatuses may be used, e.g., based in irrigation requirement, a porousness level of each plant apparatus in the set, or the like. For example, a different irrigation setting may be used for the first group of tiles and the second group of tiles, as they comprise tiles made from material with different porousness levels. In some exemplary embodiments, the irrigation setting that is used for each plant apparatus may be applied, e.g., by inserting hydrophobic material in the set of plant apparatuses, setting an irrigation quantity or frequency in an automatic irrigation system, or the like. For example, in case a bottom plant apparatus has very low porousness, hydrophobic material may be inserted to a top feeding tile that feeds the bottom plant apparatus, e.g., in the location that of the top tile is configured to feed the bottom plant apparatus. This may reduce a quantity of liquid that transfers to the bottom plant apparatus, and thereby prevent overflows from the bottom tile. As another example, in case a first plant apparatus has very low porousness and a second plant apparatus has high porousness, an automatic irrigation system may be configured to provide different quantity or frequency of irrigation to the apparatuses, e.g., providing higher irrigation quantity and/or frequency to the second plant apparatus.

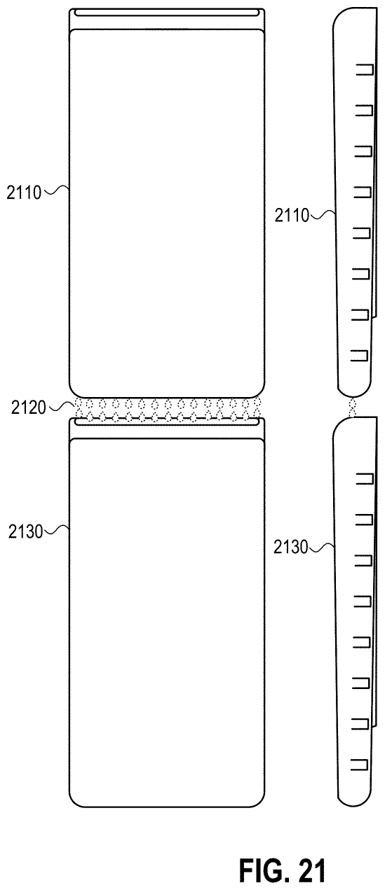

Reference is made to FIG. 21, illustrating a schematic front view and a side view of a tile assembly configuration. As illustrated in FIG. 21, Plant Apparatus 2110 may be placed above Plant Apparatus 2130, enabling Excess Liquid 2120 to flow down from Plant Apparatus 2110 to Plant Apparatus 2130. In some exemplary embodiments, Excess Liquid 2120 may flow from a top of Plant Apparatus 2110, e.g., in case of an overflow, may flow from an Exterior Surface 20 of Plant Apparatus 2110, may flow from a porous lowermost Edge 32 of Plant Apparatus 2110, or the like. In some exemplary embodiments, Excess Liquid 2120 may flow to a top opening of Plant Apparatus 2130, to the Exterior Surface 20 of Plant Apparatus 2130, to a base member of Plant Apparatus 2130, or the like. For example, in case Plant Apparatus 2130 is coupled to a Base member 24 (FIG. 1B) accumulating excess liquid, the base member may enable the excess liquid from Plant Apparatus 2130 to flow up to Plant Apparatus 2110, e.g., using osmotic pressure and capillary action enabling liquid confined by the Base member 24 to move up, similarly to the description of FIG. 4.

As illustrated in FIG. 21, Plant Apparatus 2110 and Plant Apparatus 2130 may be adhered to a vertical surface such as a wall, which may be parallel to the front and back faces of Plant Apparatus 2110 and Plant Apparatus 2130. In some exemplary embodiments, the back face the tiles that faces the wall may comprise a sealed portion, while a porous front face of the tiles may face the space in from of the wall, such as an interior indoor or outdoor space facing the wall.

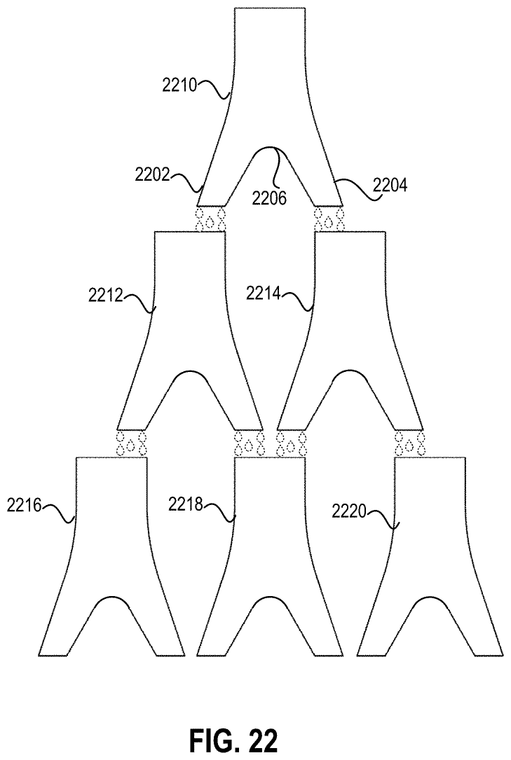

Reference is made to FIG. 22, illustrating a schematic front view of a tile assembly configuration. In some exemplary embodiments, controlling a direction of a liquid flow may enable to place tiles of a tile assembly in a desired design, configuration, or the like, e.g., such as the tile design illustrated in FIG. 22. In some exemplary embodiments, a liquid flow from one or more top tiles to a set of lower tiles may be directed down from one or more top tiles to one or more lower sets of tiles, e.g., directly down, downwards to one or more sides, or the like. In some exemplary embodiments, a downwards direction and rate of the liquid flow may be dictated by one or more materials such as a hydrophobic material that may be placed in a tile providing liquid to lower tiles. In some exemplary embodiments, a flow of liquid from a top tile may be directed to one or more designated locations, such as to one or more plant apparatuses placed below the top tile, using hydrophobic material, or any other liquid blocking material, that enables to control the liquid flow direction, the liquid flow rate, or the like. In some exemplary embodiments, the hydrophobic material in the tile may dictate the direction of the liquid and direct it towards the one or more plant apparatuses by blocking part of the liquid's exit path and directing flow of liquid from the remaining unblocked portions to the next tiles.

In some exemplary embodiments, the hydrophobic material may define a portion of plant apparatus from which the liquid is enabled to drip out in accordance with the hydrostatic pressure. For example, hydrophobic material may be placed on a first side of a liquid exit portion of a tile, e.g., a right side, directing the flow of liquid to a remaining parts of the liquid exit portion of the tile, e.g., a left side, a middle, or the like. In some exemplary embodiments, the liquid exits portion of the tiles may comprise a top opening, a porous lowermost Edge 32, or the like. In some exemplary embodiments, the hydrophobic materials may also be used to influence the flow rate of the liquid draining out of the tiles.

As illustrated in FIG. 22, Tile 2210, which may be provided with liquid from an irrigation source, enables liquid to flow to the Right Side 2204 of the tile's lowermost Edge 32 portion and to the Left Side 2202 of the tile's lowermost Edge 32 portion, without enabling liquid to flow down the Middle 2206 of Tile 2210's lowermost Edge 32 portion. In some exemplary embodiments, liquid may be prevented from flowing down through the Middle 2206 by using the hydrophobic material, glazing, or any other blocking medium to seal the Middle 2206 of the lowermost Edge 32. In some exemplary embodiments, in case liquid lands on the sealed Middle 2206, the liquid may be guided by the curve of the Middle 2206 and flow to the sides, e.g., to the Left Side 2202, to the Right Side 2204, or the like. In some exemplary embodiments, liquid may flow from Tile 2210 to Tiles 2212 and 2214, which may be similar in structure to Tile 2210, and from Tiles 2212 and 2214 to Tiles 2216, 2218, and 2220.

In some exemplary embodiments, the hydrophobic material may be used to provide a customized irrigation rate to different types of plants. For example, for a set of tiles that grow flora with low liquid utilization, the hydrophobic material may be used to lower a rate of liquid passage between tiles, and to enable liquid passage through very limited areas, thereby reducing a quantity of liquid passing to the remaining tiles. In some exemplary embodiments, a set of tiles may include one or more groups of tiles configured for different rates of irrigation. In some exemplary embodiments, controlling the direction of flow of liquid may enable to personalize the structure of the tile assembly, to form aesthetically pleasing patterns of tiles, to match the pattern of tiles to an available space, to customize the irrigation rate of each tile, or the like.

For example, a first group of one or more tiles, e.g., including Tile 2212, may correspond to a high irrigation rate matching first types of plants, while a second group of one or more tiles, e.g., including Tile 2214, may correspond to a lower irrigation rate matching second types of plants. According to this example, the Left Side 2202 of Tile 2210's lowermost Edge 32 portion, which provides liquid to Tile 2212, may be set to match the high irrigation rate necessary for Tile 2212, while the Right Side 2204 of Tile 2210's lowermost Edge 32 portion, which provides liquid to Tile 2214, may be set to match the low irrigation rate necessary for Tile 2214. This may be done by adding more hydrophobic material to the Right Side 2204 of Tile 2210, reducing the irrigation rate and amount of liquid provided to Tile 2214.

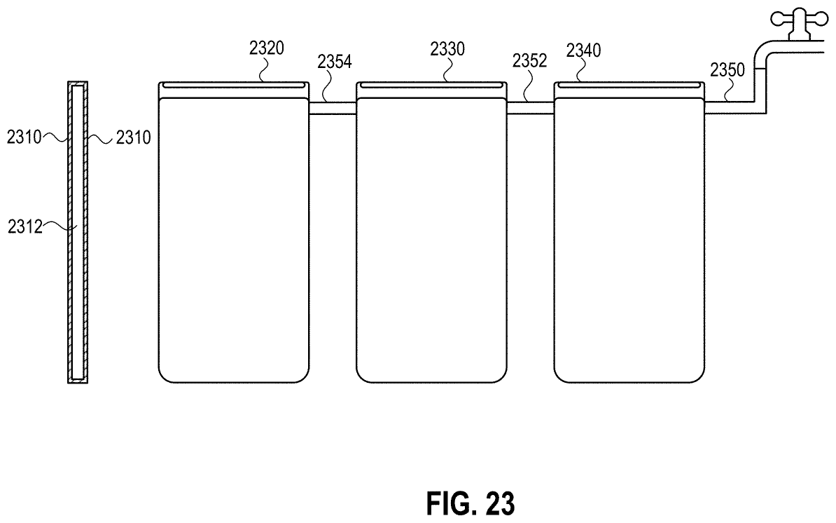

Reference is made to FIG. 23, illustrating an irrigation configuration of a parallel tile assembly. In some exemplary embodiments, a system may comprise a first Plant Apparatus 10 (FIG. 1A), which may have access to direct irrigation, and one or more plant apparatuses, which may be placed below the first plant apparatus, in parallel thereto, such as in FIG. 23, or even above the first plant apparatus. In some exemplary embodiments, the first plant apparatus and the one or more plant apparatuses may be connected with one another using a pipe configuration, enabling irrigation of the one or more plant apparatuses via the first plant apparatus and the pipe configuration. For example, excess liquid may be directed from the first plant apparatus to the one or more plant apparatuses via the pipe configuration. In some exemplary embodiments, the first plant apparatus and the one or more plant apparatuses may not be connected with one another. Instead, an irrigation source may connect to each pipe of a pipe configuration, enabling irrigation of the one or more plant apparatuses via the pipe configuration.

In some exemplary embodiments, a parallel tile assembly or system may comprise one or more plant apparatuses implemented as tiles and placed in parallel, e.g., first and second tiles. In some exemplary embodiments, an irrigation source of a first tile may enable irrigation of the second plant apparatus, e.g., via one or more pipes connecting the tiles. In some exemplary embodiments, the irrigation source may be directly associated with the first tile, which may enable to transfer the liquid to remaining tiles, e.g., utilizing the homeostasis effect causing a liquid level to equalize over connected structures, utilizing excess liquid, or the like. In some exemplary embodiments, the first tile may be irrigated with a liquid reservoir, an irrigation source, a faucet, an irrigating pipe, a drip system, manually, or the like. In some exemplary embodiments, an irrigation source of at least one first tile in the assembly may provide irrigation to the remaining tiles via pipes connecting the set of plant apparatuses to each other. In some exemplary embodiments, an irrigation source of the assembly may provide irrigation to each tiles via pipes that are attached to each tile, e.g., independently, in a closed configuration that does not enable liquid to flow between the tiles. In some exemplary embodiments, the pipe configuration may comprise one or more pipes utilized to connect between the tiles. In some exemplary embodiments, the pipes may connect the internal volumes of the tiles.

In some exemplary embodiments, as illustrated in FIG. 23, a liquid source may provide liquid to Tile 2340 via a Pipe 2350, or in any other manner. In some exemplary embodiments, when Tile 2340 is nearly filled (reaches Pipe 2352), the liquid may flow to Tile 2330 via Pipe 2352. In some exemplary embodiments, when Tile 2330 is nearly filled (reaches Pipe 2354), the liquid may flow to Tile 2320 via Pipe 2354. In some exemplary embodiments, the connecting pipes between the parallel tiles may be placed in any other height of the tiles, e.g., in a bottom wall portion of the tiles, in a medium height gradient, in the lowermost Edge 32, or the like.

In some exemplary embodiments, the tiles may not require a large interior liquid reservoir, as the internal space may be generated to have minimal dimensions for enabling sufficient liquid distribution to the external indentations or slots. In some exemplary embodiments, the minimal dimensions of each tile may include overall width of around 1 centimeter, including both walls (back and front walls) and interior space of the Internal Volume 30 between them. In some exemplary embodiments, the minimal ceramic width may be around 3 or 4 millimeters, making both walls between 6 and 8 millimeters thick, with the interior space having a width of around 2 millimeters. Alternatively, the minimal ceramic width of a wall may be below 3 millimeters, and the width of the interior space may be below 2 millimeters. In order to ease construction, the overall width of a tile may be widened, and constructed to have an overall width of up to 2 centimeters, in case small dimensions are desired. In case thick tiles are desired, any width above 1 or 2centimeters may be constructed. Alternatively, the overall width of a tile may have any other width such as 1 centimeter, 10 centimeters, 100 centimeters, or the like. As illustrated in FIG. 23, in some cases the minimal wall width of a tile back and front 2310 may be 4 millimeters, while the minimal width of the interior space 2312 may be 2 millimeters.

In an alternative embodiment (not illustrated), a liquid source may provide liquid to Tile 2340 via a Pipe 2350, to Tile 2330 via Pipe 2352, to Tile 2320 via Pipe 2354, or the like. In some exemplary embodiments, in this configuration, the liquid source may irrigate each of Pipes 2350, 2352, and 2354, e.g., via a separate pipe for each tile. In some exemplary embodiments, in this configuration, liquid may not be enabled to flow between Tiles 2340, 2330, 2320, or the like.

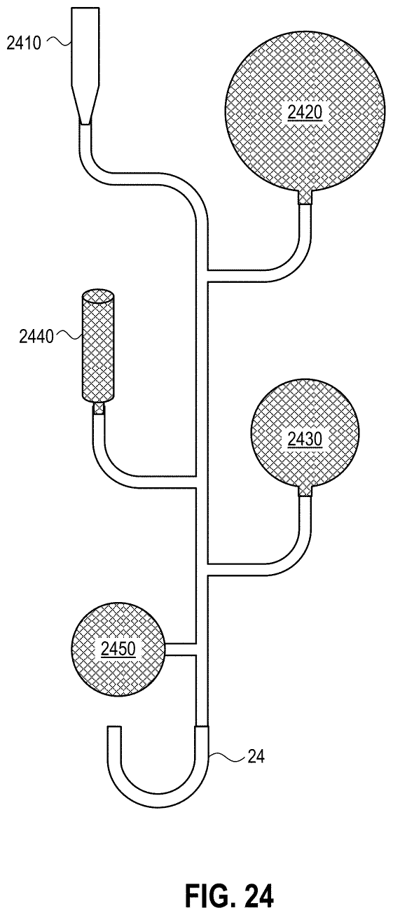

Reference is made to FIG. 24, illustrating a schematic front view of a mixed tile and vase assembly. In some exemplary embodiments, the mixed tile and vase assembly may comprise a plurality of tiles and vases disposed in a mixed assembly configuration, each one comprising an implementation of Plant Apparatus 10 (FIG. 1A, FIG. 4, FIG. 16, or the like). In some exemplary embodiments, the mixed tile and vase assembly may be configured to be coupled to a vertical surface such as a wall, or may not configured be configured to be suspended. For example, the mixed tile and vase assembly may be configured to be placed in a center of a room, on top of a flat surface such as a table, a floor, or the like. In some exemplary embodiments, as illustrated in FIG. 24, the mixed tile and vase assembly may comprise Tiles 2420, 2430, and 2450, having a flat round shape with or without a sealed back, potentially having any other flat shape, and Vase 2440 having porous material in all sides. In some exemplary embodiments, an Irrigation Source 2410 may provide liquid to the mixed tile and vase assembly via a pipe configuration that reaches Tiles 2420, 2430, and 2450, and Vase 2440, e.g., enabling fluid communication between components of the assembly. In some exemplary embodiments, a Base member 24 is provided to accumulate excess liquid from the assembly, and possibly to return excess liquid to the above tiles or vase.

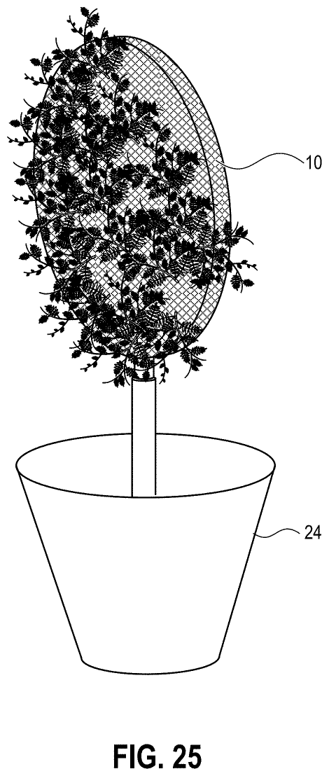

Reference is made to FIG. 25, illustrating a schematic front view of a Plant Apparatus 10 implemented as an independent non-hang able tile. In some exemplary embodiments, a rounded shaped tile, or any other shaped tile, may be disposed in an independent configuration that is not configured to be suspended or hung on a vertical surface such a wall, and is configured to be disposed independently. In some exemplary embodiments, as the tile may not be configured to be hung, both front and back faces of the tile may comprise porous material enabling flora growth. In some exemplary embodiments, as illustrated in FIG. 25, an irrigation source may provide liquid the non-hangable Tile 10 via a pipe. In some exemplary embodiments, a Base member 24 is provided to accumulate excess liquid from the non-hangable Tile 10, e.g., from a pipe connecting the non-hangable Tile 10 to the Base member 24. In some exemplary embodiments, the Base member 24 may enable liquid to be returned up to the non-hangable Tile 10, such as via the pipe connecting them.

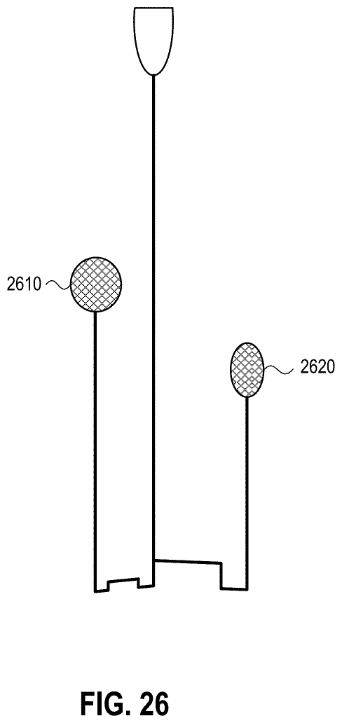

Reference is made to FIG. 26, illustrating a schematic front view of an independent non-hangable tile assembly. In some exemplary embodiments, a system including a plurality of tiles may be disposed in an independent configuration that is not configured to be suspended or attached to a vertical surface, but rather be placed on top of a flat surface, at a center of a room, on a table, on a floor, outdoors, or the like. In some exemplary embodiments, each tile in the assembly may enable flora growth on both faces of the tile, as sealing may not be necessary. In some exemplary embodiments, as illustrated in FIG. 26, an irrigation source provides liquid to Tiles 2620 and 2610 via a pipe configuration. In some exemplary embodiments, the pipe configuration may connect the tiles to each other and to the irrigation source, enabling the liquid to be distributed to the tiles in a uniformed liquid level.

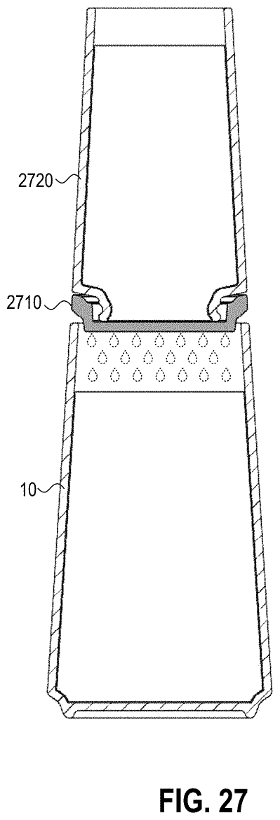

Reference is made to FIG. 27, illustrating a longitudinal cross-section of a limescale filtering configuration, or a filtering configuration of any other material, deposit, impurity, or the like. The filtering configuration will be exemplified herein with respect to limescale. In some exemplary embodiments, high quantities of limescale in the liquid may be damaging for the plant apparatus, for its components, or the like, damaging its functionality. In some exemplary embodiments, in case the liquid inserted to a Plant Apparatus 10 is high in limescale, damage can be caused to the porousness of the plant apparatus, as it may cause the Indentations 22 to be blocked.

In some exemplary embodiments, irrigation liquid may be filtered using a clay or ceramic cylinder or any other shaped clay Filter 2710, e.g., made from clay, from ceramic material, from the same material as the plant apparatus or of any other porous filtering material. In some exemplary embodiments, the ceramic Filter 2710 may be configured to be placed on a top opening of the Plant Apparatus 10. In some exemplary embodiments, a Liquid Reservoir Tank 2720 may be configured in size and shape to be placed above the ceramic Filter 2710. In some exemplary embodiments, liquid in Liquid Reservoir Tank 2720 may be filtered by the ceramic Filter 2710 before flowing to the internal volume of the Plant Apparatus 10. In some exemplary embodiments, liquid in Liquid Reservoir Tank 2720 may or may not comprise limescale, which may be filtered by Filter 2710 upon seeping out of the Filter 2710 into the Plant Apparatus 10, e.g., providing Plant Apparatus 10 with liquid that is filtered from limescale. In some exemplary embodiments, the Filter 2710 may enable the liquid to seep from liquid Tank 2720, placed with its opening facing a top of Filter 2710, through Filter 2710, into a top opening of Plant Apparatus 10, thereby filtering out the limescale from liquid provided to Plant Apparatus 10.

In some exemplary embodiments, in case Filter 2710, which is made from porous material, is clogged from limescale, Filter 2710 may be easily replaced with a different clay piece acting as a filter. In some exemplary embodiments, Filter 2710 may be an independent modular component, a porous clay wall of top liquid Tank 2720, or the like.

In some exemplary embodiments, filtering the limescale, such as using Filter 2710, may enables to reduce an irrigation frequency, as the liquid that is conveyed through Filter 2710 into the Plant Apparatus 10 may be conveyed in a slow rate, e.g., taking days or even weeks to be fully transferred, depending on the size of the filter and its level of porousness. In some exemplary embodiments, the top liquid Tank 2720 may be considered to be a liquid reservoir that can be used to provide large amounts of liquid to the Plant Apparatus 10 without worrying about irrigation, for example, in case it is desired to irrigate flora for a longer than usual period. For example, in case a user wishes to leave his apartment for a few weeks during a vacation, a large liquid Tank 2720 full of liquid may be used in combination with the Filter 2710 to ensure the Flora 102 (FIG. 2A) of Plant Apparatus 10 is well irrigated during the vacation, continuously irrigating the flora during the entire period of absence. Specifically, as Filter 2710 decreases the flow rate of the liquid, compared to direct irrigation, the irrigation process may be delayed so that it can be conducted over several days or weeks, slowly dripping out filtered liquid to Plant Apparatus 10. In some exemplary embodiments, the Filter 2710 may be selected to have a porousness level that enables a sufficient rate of liquid to flow in the Plant Apparatus 10, that enables flora to flourish.

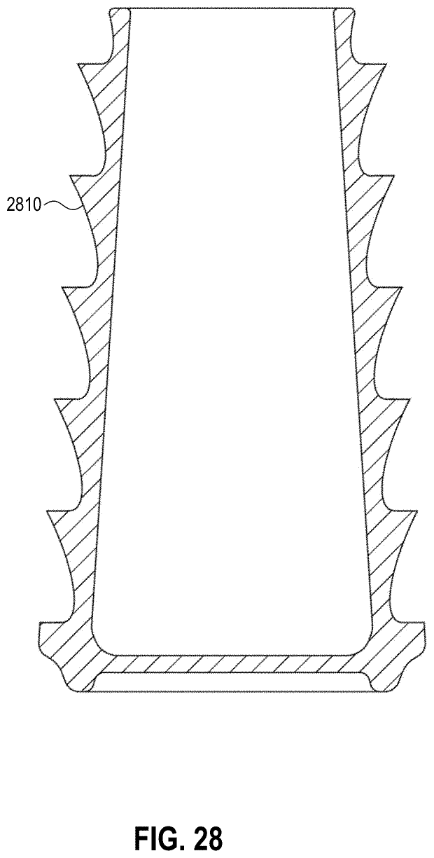

Reference is made to FIG. 28, illustrating a longitudinal cross-section of a customized configuration of a Plant Apparatus 10 (FIG. 1A). In some exemplary embodiments, shapes and dimensions of the exterior surface may be customized to specific plant types and corresponding plant needs. In some exemplary embodiments, indentations may be customized in size and shape according to an amount of liquid needed for a target plant type. In some exemplary embodiments, the larger the indentation, the more liquid is provided to the flora growing on the external wall of the plant apparatus, and vice versa.

In some exemplary embodiments, as illustrated in FIG. 28, instead of indentations, Plant Apparatus 10 may comprise Bulges 2810 sticking out, which may form a thorn-shaped exterior surface. In some exemplary embodiments, the thorns-shaped exterior surface may enable plants that have a difficulty holding on to indentations, to anchor to the bulges of the Plant Apparatus 10. In some exemplary embodiments, Bulges 2810 may enable plants to easily hold on to the Plant Apparatus 10 without accumulating excessive liquid, thereby suiting plant types that do not require much liquid and have low anchoring abilities. In some exemplary embodiments, liquid in Plant Apparatus 10 may be configured to seep out through Bulges 2810 instead of the absent indentations.

In some exemplary embodiments, the material of the Plant Apparatus 10 may be customized according to the various needs of the plant types. For example, plants that prefer more liquid may be supplied with a Plant Apparatus 10 created from a material that is very liquid exerting, while plants that flourish with less liquid may be supplied with a Plant Apparatus 10 created from a material that is less liquid exerting. In some exemplary embodiments, a set or assembly of plant apparatuses may be customized for different types of plants and therefore may be composed of different materials having different porousness, each matching a type of plant. In some exemplary embodiments, the irrigation may be affected, in rate and quantity, from the porousness of the materials used to create a Plant Apparatus 10. For example, a flow from a first tile being composed of a low-porousness material to a next tile being composed of a high-porousness material may be slow, while a flow in the other way around may be fast. In some exemplary embodiments, when building a tile or vase assemble, the porousness of their materials may be taken into account when setting up an irrigation system.

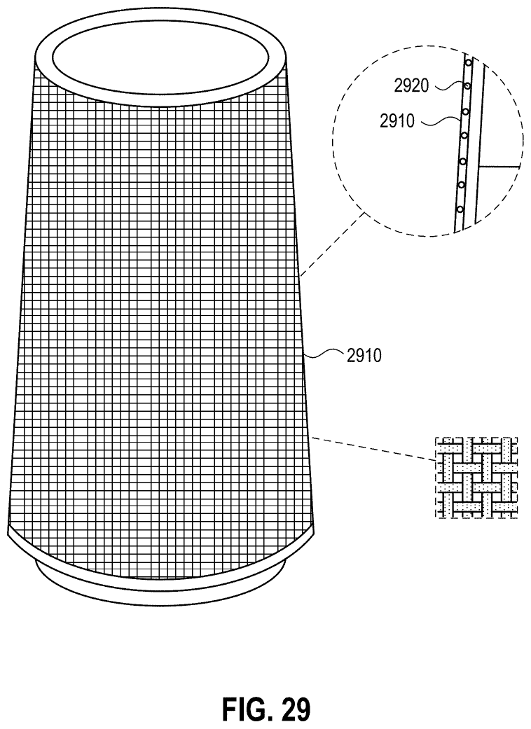

Reference is made to FIG. 29, illustrating a schematic front view of a mesh that is configured for covering a Plant Apparatus 10 (FIG. 1A). In some exemplary embodiments, a Plant Apparatus 10 may be provided with supplement components such as a Mesh 2910 configured to be coupled to the Plant Apparatus 10 around the exterior surface, to cover the Plant Apparatus 10, to cover soil placed around the Plant Apparatus 10, to cover the roots from the light, or the like.

In some exemplary embodiments, some plant types that require soil may be provided with a Plant Apparatus 10 with an exterior surface that is coupled to soil. In some exemplary embodiments, the soil may be attached to the exterior surface of the plant apparatus using a Mesh 2910 from fabric, felt, synthetic material, or the like, preferably not from cotton material or a material that can easily rot. The Mesh 2910 may be used to press soil, placed between the Mesh 2910 and the Plant Apparatus 10, to the Plant Apparatus 10. In some exemplary embodiments, covering the Plant Apparatus 10 with the Mesh 2910 may be advantageous for plants that require soil and cannot hold themselves, as the Mesh 2910 provides both an anchoring medium and a soil attaching medium. In some exemplary embodiments, herbs may constitute a challenge as they deepen their roots, prefer to keep their roots in the dark, and are not able to hold on to the external cells or indentations (e.g., Indentations 22 of FIG. 1A). In some exemplary embodiments, covering the plant apparatus with the Mesh 2910 may enable herbs to grow their roots in the dark under the Mesh 2910 while simultaneously anchoring the roots to the plant apparatus.

In some exemplary embodiments, Seeds 2920 may be enabled to be retained in the plurality of indentations below the Mesh 2910, inside the Mesh 2910, e.g., embedded within the fabric of the Mesh 2910, or the like, thereby providing a dark environment for roots of the flora developing from the Seeds 2920. In some exemplary embodiments, in some cases, the Mesh 2910 may be configured to include embedded Seeds 2920 inside pores of the Mesh 2910. In some exemplary embodiments, upon covering the plant apparatus with Mesh 2910 and inserting liquid to Internal Volume 30 of the plant apparatus, Seeds 2920 may germinate and develop Roots 100 (FIG. 2A) between the Mesh 2910 and the external wall of the plant apparatus, e.g., in the dark. In case the Seeds 2920 are not embedded within Mesh 2910, the Seeds 2920 may be inserted into the indentations prior to dressing the Mesh 2910 around the Plant Apparatus 10, e.g., enabling Mesh 2910 to hold the Seeds 2920 in the indentations. Alternatively, live flora or germinated seeds may be provided and anchored to the Plant Apparatus 10.

In some exemplary embodiments, the Mesh 2910 may be provided in shape and size that correspond to the shape and size of the target Plant Apparatus 10, thereby enabling to dress the Mesh 2910 upon a plant apparatus, cover the plant apparatus, or the like. In some exemplary embodiments, the Mesh 2910 may be provided together with Seeds 2920 embedded therein, separately from the Seeds 2920, with slow-release gel, as part of a plant kit, or the like.

In some exemplary embodiments, a plant kit provided to a client may comprise, in addition to a Plant Apparatus 10, a plant carpet comprising a carpet of live flora with or without soil, e.g., preferably without soil. In some exemplary embodiments, the plant carpet may have a reduced depth compared to typical plant carpets, e.g., a depth that is below a threshold such as a threshold of 0.5 centimeter, of 1 centimeter, or the like. In some exemplary embodiments, the plant kit may comprise a coupling medium that is configured for coupling the plant carpet to the plant apparatus, e.g., a rubber band, a button, a zipper, or the like, e.g., until the roots of the plant carpet anchor to the indentations of the Plant Apparatus 10. In some exemplary embodiments, upon obtaining the plant kit, the client may be enabled to dress the plant carpet around the Plant Apparatus 10 using the coupling medium, thereby enabling roots of the plant carpet to anchor to the exterior surface of the plant apparatus.

In some exemplary embodiments, in order to create the plant carpet, Seeds 2920 may be germinated independently of the Plant Apparatus 10, e.g., on a platform mat, on a mold, or the like, e.g., in a greenhouse. In some exemplary embodiments, the carpet may be sent to a client for coupling to the Plant Apparatus 10. In some exemplary embodiments, a plant carpet may be configured to be dressed upon a Plant Apparatus 10, and may contain flora, and possible soil or a platform mat. In some exemplary embodiments, a plant carpet may comprise a platform mat holding plants or sprouts together. In some exemplary embodiments, the platform mat may comprise a fabric or mesh enabling germination of seeds there above. In some exemplary embodiments, instead of a platform mat, a mold may be used to germinate the seeds, enabling to detach the carpet from the mold without requiring a platform mat for connecting the germinated seeds, e.g., utilizing the roots of the sprouted seeds instead. In some exemplary embodiments, in some cases, such as in case the seeds include grass seeds, chia seeds, or the like, the carpet may be integrated and held together using roots alone, without a platform mat. In some exemplary embodiments, the plant carpet can be grown by a vendor separately such as in a greenhouse over a tile-like surface in a size corresponding to Plant Apparatus 10, which is then peeled off the surface and sent to a client.

In some exemplary embodiments, a plant carpet may be coupled or linked to the Plant Apparatus 10 using a button, a rubber band, a zipper, or any other coupling medium. In some exemplary embodiments, the plant carpet may be provided as a flat shaped plate, rolled up as a roll, or the like.

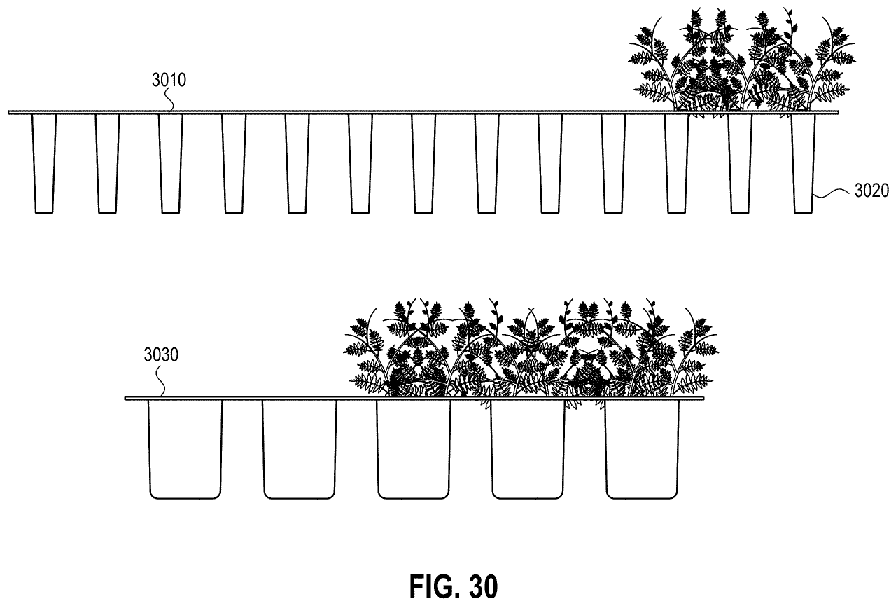

Reference is made to FIG. 30, illustrating plant plugs configured to be coupled or attached to Plant Apparatus 10 (FIG. 1A). In some exemplary embodiments, Plant Apparatus 10 may be configured to have one or more plant plugs attached thereto. In some exemplary embodiments, the plant plugs may be grown in plant plug trays such as germination trays with slots, cells, holes, or the like, each comprising soil and a plant. In some exemplary embodiments, the plant plugs may typically be germinated within symmetrically-shaped deep slots that have similar depths and widths. In some exemplary embodiments, symmetrically-shaped deep plugs may be relatively thick, and therefore may not be suited for being coupled to the Plant Apparatus 10. In some exemplary embodiments, alternative non-symmetrically-shaped flat plant plugs may be developed, grown, geminated, or the like, e.g., in a greenhouse, and utilized for coupling to the Plant Apparatus 10.

In some exemplary embodiments, instead of using symmetrically-shaped deep cells, having symmetrical or similar dimensions of depth and width, tray slots with a geometrical reduced volume in one dimension of the cell may be used. In some exemplary embodiments, one dimension such as a depth, a width, or a height of the plant plugs may be reduced to comprise one centimeter or less. In some exemplary embodiments, the slots may be flat in at least one dimension, geometrically restricting the plant roots to grow mostly flatly in one dimension. In some exemplary embodiments, geometrically limiting the plug growth to mostly one dimension may cause the plugs to match the Apparatus 10, e.g., without forming bulges on the Apparatus 10 when dressed upon the Apparatus 10.

In some exemplary embodiments, one dimension of a plant plug may be one centimeter or less, while other dimensions of the plant plug may be two centimeter or more. For example, the width 3010 of the slots may be reduced to around 1 centimeter, leaving the depth 3030 and length 3020 with typical dimensions, e.g., a depth of 3 centimeters and a length of 4 centimeters, or any other dimensions that are above 2 centimeters. Alternatively, the depth of the slots may be reduced to around 1 centimeter, leaving the width and length with typical dimensions, e.g., a width of 3 centimeters and a length of 4 centimeters, or any other dimensions that are above 2 centimeters. Alternatively, the length of the slots may be reduced to around 1 centimeter, leaving the width and depth with typical dimensions, e.g., a width of 3 centimeters and a depth of 3 centimeters, or any other dimensions that are above 2 centimeters. In some exemplary embodiments, a plant plug tray may comprise a plurality of individual cells, each cell comprising a plant plug having one dimension of one centimeter or less, and other remining dimensions being two centimeter or more.

In some exemplary embodiments, the plant plugs may be attached or coupled to the Apparatus 10 so that their flat face is adjacent to the exterior face of Apparatus 10. In some exemplary embodiments, in case the width or depth of the tray slots are reduced, coupling the flat face of the plant plugs to the Apparatus 10 may result with flat plugs that have flora growing at the highest side, growing in a direction that is parallel to a longitude axis of the Apparatus 10. In some exemplary embodiments, in case the length of the tray slots is reduced, coupling the flat face of the plant plugs to the Apparatus 10 may result with flat plugs that have flora growing from the flat exterior face of the plant plug, growing in a direction that is orthogonal to a longitude axis of the Apparatus 10. In some exemplary embodiments, it may be desired to geometrically reduce the tray slots in their width or depth dimension, instead of in the length dimension, so that the flora will grow in the direction parallel to the longitude axis of the Apparatus 10. In some exemplary embodiments, the one dimension that is reduced in size may a depth or width of the plant plug, which may be defined by a cell in which the plant plug was grown within the plant plug tray.

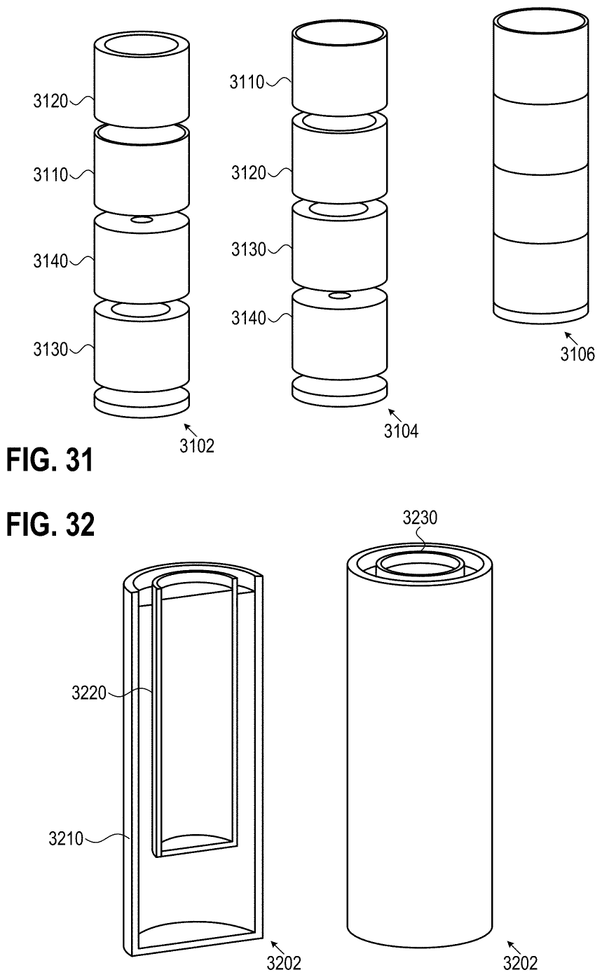

Reference is made to FIG. 31, illustrating a schematic exploded view and a front elevation view of a modular plant apparatus.

In some exemplary embodiments, Modular Plant Apparatus 3104 may comprise a plurality of attachable plant apparatus blocks, each of which may or may not comprise an individual plant apparatus, e.g., Block 3110, Block 3120, Block 3130, and Block 3140. In some exemplary embodiments, the blocks may each have a hollow internal space in a desired diameter. In some exemplary embodiments, the blocks may have a top opening and/or a bottom opening, may be sealed with porous material atop and/or on the bottom, may be sealed with non-porous material atop and/or on the bottom, or the like. In some exemplary embodiments, a base member may be placed below a modular plant apparatus assembly, e.g., the Modular Plant Apparatus 3104, 3102, 3106, or the like, to accumulate excess liquid. In some exemplary embodiments, the modular structure may be useful for long structures of plant apparatuses, such as for creating a vase tube of five meters, that typically suffers from high water pressures.

In some exemplary embodiments, each block of Modular Plant Apparatus 3104 may have an overall equal diameter in the depth or width dimension, e.g., in a dimension that is orthogonal to the longitude axis of the Modular Plant Apparatus 3104. In some exemplary embodiments, each block may include a hollow internal portion defined by external walls, wherein the longitude diameter of the block includes a width of walls of both sides and a width of the internal volume between the walls. By ensuring all blocks have an identical diameter, a uniform look of a vase or tile, e.g., Modular Plant Apparatus 3106, is provided when the blocks are attached together, regardless of the various sizes of the internal space of each block. In some exemplary embodiments, the blocks may have walls of unified depth or thickness, of different depth or thickness, or the like, and in order to ensure an equal diameter, the width of the internal volume therebetween may include the offset remaining from the walls' depths. For example, in case the equal diameter of the blocks is determined as 8 centimeters, and the width of the walls in a block is 2 centimeters together, the volume of the block may be constructed to have a width of 6 centimeters, so that together the diameter may correspond to 8 centimeters, e.g., the identical diameter.

In some exemplary embodiments, in order to balance a liquid or water pressure within Modular Plant Apparatus 3104, the blocks may be ordered so that walls of the blocks may gradually thicken. The walls may be ordered to be thinnest at a top block and thickest at the bottom block. For example, as illustrated in FIG. 31, the side walls of Block 3110, which may be placed at the top position, may be the thinnest, the side walls of Block 3120 may be thicker, the side walls of Block 3130 may be yet thicker, and the side walls of Block 3140 positioned at the bottom may be the thickest, e.g., thereby balancing the liquid pressure within Modular Plant Apparatus 3104 in case of open tops and bottoms. In some exemplary embodiments, the internal hollow volume of each block may be constructed to oppositely correlate to the thickness of the walls, to thereby provide equal overall diameters of the blocks.

In some exemplary embodiments, changing an order of the blocks may affect the water pressure of the modular plant apparatus. In some cases, in order to create a long plant apparatus tube without separations between the blocks, it may be necessary to incorporate different wall thickness in the interior of the blocks so that the water pressure is balanced. In some exemplary embodiments, the order in which the blocks are placed may be modified to any desired order, e.g., by simply disassembling the blocks and re-arranging them in a different order as desired. For example, in order to obtain Modular Plant Apparatus 3102, Modular Plant Apparatus 3104 may be re-arranged such as by placing Block 3120 on top of Block 3110, and placing Block 3140 on top of Block 3130, as opposed to the order of blocks in Modular Plant Apparatus 3104. In other examples, the blocks may be assembled and re-ordered in any other selected manner or order. For example, Block 3140 may be placed on top of Block 3110.

In some exemplary embodiments, after assembling and positioning the blocks on top of each other in a selected order, the blocks may be adhered to each other using one or more adhering mechanisms such as screws, threading techniques, O-rings, elastic or rubber bands, gluing material, or the like. In some exemplary embodiments, the adhering mechanisms may be permanent or temporary. In some exemplary embodiments, a metal 0-ring may be attached around each block, and the rings may be secured together using another ring, a clip, a fastener, a rope, or any other securing means. Alternatively, an adhering mechanism may utilize a shape of the blocks to mechanically match to each other, such that each block would be able to be positioned above another block without using any additional means, e.g., similar to LEGO™ pieces. For example, in case the bottom and top of each block is flat, the blocks may be enabled to be placed on top of each other. As another example, in case the top of each block has a socket or dent, and each bottom of each component has a matching bulge, the components may be enabled to be securely placed on top of each other.

In some exemplary embodiments, the blocks may be adhered to each other via an internal structure or connection, via an external structure or connection, or the like, e.g., in a portion of Modular Plant Apparatus 3104 that stays consistent over all blocks. For example, in case a longitude axis in a certain location includes a hollow portion of all of the blocks, the blocks may be adhered internally, while in case a longitude axis in a certain location includes a wall portion of all of the blocks, the blocks may be adhered externally or internally via the wall portion.

In some exemplary embodiments, in case at least some of the blocks have top and bottom openings, it may be challenging to change an order of the blocks or replace a damaged block while the blocks are filled with liquid. In some exemplary embodiments, in order to change an order of the blocks or replace a damaged block, an internal pipe may be configured to be placed internally in the open blocks and be used for pumping out the liquid before removing a block for any purpose. In some exemplary embodiments, an internal shutter may be configured to be placed between each two blocks, and enable to screen off a block by closing the shutter. For example, in case a third block from the top is damaged, a shutter between the second and third block may be opened, thereby disconnecting the liquid above the third block. Accordingly, upon lifting up the first and second blocks, the liquid may not drip out, and enable the user to safely detach the third block with minimal liquid dripping. Upon inserting a new block instead of the third block, the first and second blocks may be mounted thereon, and the shutter may be closed to return to the normal open configuration. Any other type of barrier or screen may be used to separate two blocks, sections, or the like, upon disassembling a modular plant apparatus. In some cases, barriers or screens between blocks may also be used for balancing liquid pressure, e.g., by switching a location of a barrier periodically according to a desired order.

In some exemplary embodiments, internal volumes of blocks, as well as block walls, may have various diameters, sizes, or shapes. For example, some blocks may have identical wall depths and internal volume diameters. As another example, some blocks may have one or more wall depths and internal volume diameters that are different from each other. In some cases, internal walls of a block may have a gradual thickness gradient, e.g., similar to FIGS. 9-11, that may be internal or external. For example, in case of an internal thickness gradient, the external wall may appear flat and unified in depth, but the liquid pressure may be balanced due to a gradual thickness within the block that is invisible from an external perspective. Any of the previously described plant apparatuses may or may not comprise an internal thickness gradient, an external thickness gradient, or the like. In some exemplary embodiments, internal gradual thickness may create a uniform look of the apparatus where the outside appears to have a unified width but the width on the inside is not unified. This may be useful in multiple configurations, such as for assembling plant apparatus blocks that have unbalanced water pressure and need to match each other's dimensions, for decorative purposes, or the like.

In some exemplary embodiments, each block may be structured to incorporate attributes that match a type of plant, e.g., according to its wall thickness, firing temperature, material, by incorporating a mesh, adding soil, or the like. In some exemplary embodiments, the flow rate of liquid within the modular plant apparatus may depend on an order of the blocks, the thickness of walls of each block, or the like. Accordingly, a single modular plant apparatus comprising a plurality of blocks may enable growth of a large variety of plant types. For example, a single modular plant apparatus may include a top block with thick walls that matches plant types that prefer moister over liquid, such as orchids, and a next block may be covered by a mesh to enable growth of plant types that require a dark environment for their roots, such as herbs.

Reference is made to FIG. 32, illustrating a longitudinal cross-section view of a plant apparatus. In some exemplary embodiments, in order to reduce a liquid pressure of Plant Apparatus 3202, an additional plant apparatus such as Plant Apparatus 3220 may be placed within Plant Apparatus 3202, with a defined space between the Walls 3210 of Plant Apparatus 3202 and Plant Apparatus 3220. In some exemplary embodiments, Plant Apparatus 3220 may be composed of a porous body, a porous bottom edge, or the like. In some exemplary embodiments, liquid inserted into Plant Apparatus 3220 may drift slowly into Plant Apparatus 3202, thereby reducing a liquid pressure in Plant Apparatus 3202.

In some exemplary embodiments, Plant Apparatus 3220 may be secured to Plant Apparatus 3202 using one or more adhering mechanisms such as an external attachment via a top portion or Lid 3230 of Plant Apparatus 3220, which may be attached to a lid of Plant Apparatus 3202 or to any other portion of Plant Apparatus 3202. In some exemplary embodiments, Plant Apparatus 3220 may be secured to Plant Apparatus 3202 via one or more internal attachment such as between a wall of Plant Apparatus 3220 and Plant Apparatus 3202, a bottom edge of Plant Apparatus 3220 and Plant Apparatus 3202, or the like.

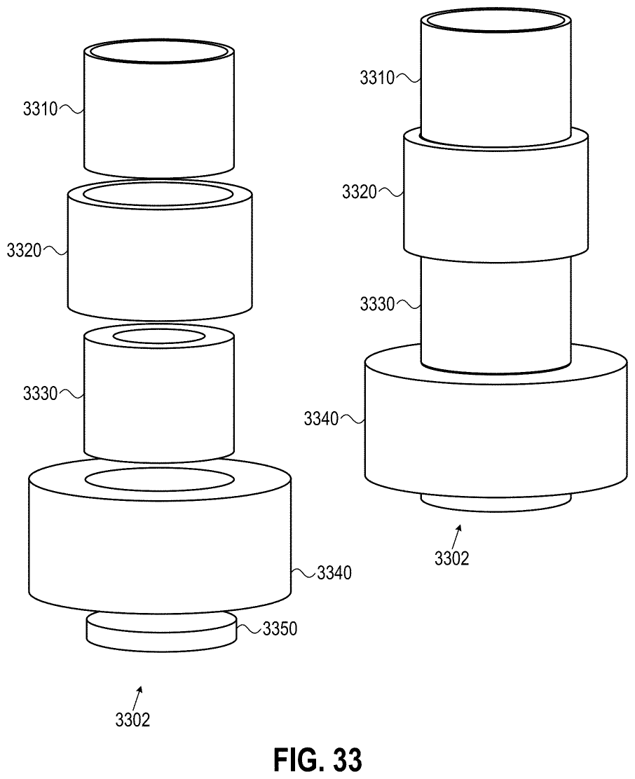

Reference is made to FIG. 33, illustrating a schematic exploded view and a front elevation view of a modular plant apparatus. In some exemplary embodiments, Modular Plant Apparatus 3302 may correspond to Modular Plant Apparatus 3102, 3104, and 3106 of FIG. 31. In some exemplary embodiments, in contrast to the modular plant apparatuses of FIG. 31, Modular Plant Apparatus 3302 may be assembled of blocks that do not have an identical diameter. For example, Modular Plant Apparatus 3302 may be assembled of Block 3310, which may be positioned above Block 3320 which is wider than Block 3310. Block 3330, positioned below Block 3320, may have a reduced width compared to Block 3320, and Block 3340 positioned at the bottom may be wider than all of the above blocks. Alternatively, Modular Plant Apparatus 3302 may be assembled of any other order of Blocks 3310-3340, or of any other blocks with non-identical widths. A Base Member 3350 may be placed below a modular plant apparatus assembly, e.g., the Modular Plant Apparatus 3302, to accumulate excess liquid therefrom.

In some exemplary embodiments, in order to enable assembling the blocks of Modular Plant Apparatus 3302 on each other, each two blocks may have at least a portion of the walls that overlap, e.g., ensuring that a block will not collapse into a subsequent block.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A plant apparatus for plant growth comprising:
an internal volume configured to retain liquid; and
an exterior surface having a plurality of indentations that are suitable for retaining seeds therein, wherein the exterior surface is made from a porous material enabling the liquid to seep out from the internal volume to the indentations of the exterior surface, wherein the exterior surface enables proliferation of plants thereacross.

2. The plant apparatus of claim 1, wherein the plant apparatus is configured to be suspended on a vertical surface, wherein the plant apparatus further comprises a sealed back portion that prevents the liquid from seeping out from the internal volume to the vertical surface, wherein the plant apparatus is open-topped, enabling liquid from above to enter the internal volume.

3. A system comprising the plant apparatus of claim 2 and a second plant apparatus, wherein the second plant apparatus is configured to be hung on the vertical surface above the plant apparatus, wherein excess liquid from the second plant apparatus is directed to the internal volume of the plant apparatus, wherein the excess liquid is provided from an exterior surface of the second plant apparatus, from an overflow of a top opening of the second plant apparatus, or from a porous lowermost edge of the second plant apparatus.

4. The plant apparatus of claim 1, wherein the exterior surface further includes one or more sealed portions that prevent the liquid from passing therethrough, wherein plant growth is inhibited upon the one or more sealed portions, wherein the one or more sealed portions comprise partial sealing of one or more indentations of the plurality of indentations, wherein the partial sealing enables a reduced amount of liquid to seep out through the one or more indentations.

5. The plant apparatus of claim 1, wherein the exterior surface further includes one or more sealed portions that prevent the liquid from passing therethrough, wherein plant growth is inhibited upon the one or more sealed portions, wherein the one or more sealed portions comprise partial sealing of one or more indentations of the plurality of indentations, wherein the plant apparatus comprises a graduated sealing of the exterior surface comprising at least a minimum sealing changing to a maximum sealing, said minimum sealing disposed above the maximum sealing, thereby enabling to equalize a hydrostatic pressure within the plant apparatus.

6. The plant apparatus of claim 1 further comprises a graduated depth of the exterior surface comprising at least a minimum thickness gradually changing to a maximum thickness, said minimum thickness disposed above the maximum thickness, whereby a hydrostatic pressure of the liquid within the plant apparatus is influenced by the graduated depth of the exterior surface, wherein the graduated depth is created by gradually altering depths of the plurality of indentations, wherein the minimum thickness corresponds to a deep shape and the maximum thickness corresponds to a shallow shape.

7. The plant apparatus of claim 1 further comprises a graduated depth of the exterior surface comprising at least a minimum thickness gradually changing to a maximum thickness, said minimum thickness disposed above the maximum thickness, whereby a hydrostatic pressure of the liquid within the plant apparatus is influenced by the graduated depth of the exterior surface, wherein the graduated depth is created by gradually altering dimensions of the plurality of indentations, wherein the minimum thickness corresponds to a large indentation diameter and the maximum thickness corresponds to a small indentation diameter that is smaller than the large indentation diameter, wherein the large indentation diameter and the small indentation diameter have a same shape.

8. The plant apparatus of claim 1 further comprises a graduated depth of the exterior surface comprising at least a minimum thickness gradually changing to a maximum thickness, said minimum thickness disposed above the maximum thickness, whereby a hydrostatic pressure of the liquid within the plant apparatus is influenced by the graduated depth of the exterior surface, wherein the graduated depth is created by gradually altering shapes of the plurality of indentations, wherein the minimum thickness corresponds to a sharp shape and the maximum thickness corresponds to a round shape.

9. A system comprising the plant apparatus of claim 1, and one or more plant apparatuses, wherein the plant apparatus and the one or more plant apparatuses are connected with one another using a pipe configuration, wherein irrigation of the one or more plant apparatuses is enabled via the plant apparatus and the pipe configuration.

10. A system comprising a set of plant apparatuses comprising the plant apparatus of claim 1, wherein the set of plant apparatuses comprises a first group of plant apparatuses that is configured to be utilized for a first type of plant associated with a first irrigation requirement and a second group of plant apparatuses that is configured to be utilized for a second type of plant associated with a second irrigation requirement, wherein the first group of plant apparatuses comprises a first porousness level that matches the first irrigation requirement, and the second group of plant apparatuses comprises a second porousness level that matches the second irrigation requirement.

11. A method comprising:
determining an irrigation setting for a set of plant apparatuses comprising the plant apparatus of claim 1, wherein the set of plant apparatuses comprises a first group of plant apparatuses having a first porousness level and a second group of plant apparatuses having a second porousness level, wherein said determining is based on the first and second porousness levels; and
applying the irrigation setting for irrigating the set of plant apparatuses, wherein the said applying the irrigation setting comprises setting an irrigation quantity or frequency in an automatic irrigation system, or inserting hydrophobic material in the set of plant apparatuses.

12. The plant apparatus of claim 1 comprising a lid member configured to seal a top opening of the plant apparatus, wherein the lid member comprises an internal liquid level sensor configured to measure a liquid level within the internal volume, wherein an exterior surface of the lid member comprises a light sensor configured to measure an exposure level of the lid member to light, wherein the lid member is configured to signal the liquid level and the exposure level to a user via a signaling mechanism, wherein said signaling mechanism is at least one of: a buoy, a side pipe, or indication lights, wherein the side pipe is parallel to a longitude axis the plant apparatus and has fluid communication with the internal volume.

13. The plant apparatus of claim 1 comprising a base member disposed basally supporting a body of the plant apparatus, wherein the base member is configured to accumulate excess liquid from the plant apparatus, wherein the base member comprises an ultrasonic transducer configured to evaporate excess liquid from the base member.

14. The plant apparatus of claim 1 comprising a top air pump and a bottom air pump, wherein the top air pump and the bottom air pump are placed in different height gradients, wherein said top and bottom air pumps are configured to control an air pressure within the plant apparatus, thereby influencing a rate of liquid flow from the internal volume to the exterior surface, wherein said top air pump is configured to increase the air pressure and said bottom air pump is configured to decrease the air pressure.

15. The plant apparatus of claim 1 comprising:
a ceramic filter configured to be placed on a top opening of the plant apparatus; and
a liquid reservoir tank that is configured in size and shape to be placed above the ceramic filter, whereby liquid in the liquid reservoir tank is filtered by the ceramic filter before flowing to the internal volume of the plant apparatus.

16. The plant apparatus of claim 1 configured to have a plant plug attached thereto, wherein one dimension of the plant plug is one centimeter or less, wherein the one dimension is a width, a length, or a depth.

17. The plant apparatus of claim 1 comprising a body bounding the internal volume, the body comprises a porous material selected from the group of: clay, polymer, concrete, resin, fabric, and microfiber.

18. The plant apparatus of claim 1 comprising a mesh that is configured to be coupled to the plant apparatus around the exterior surface, wherein the seeds are enabled to be retained in the plurality of indentations below the mesh or inside pores of the mesh, thereby providing a dark environment for roots of the plants.

19. A method comprising:
obtaining a mesh, wherein the mesh is configured to be dressed on the plant apparatus of claim 1, wherein the mesh comprises embedded seeds;
dressing the mesh around the plant apparatus, wherein the mesh is tightly coupled to the plant apparatus; and
after performing said dressing, inserting liquid to the internal volume in order to germinate the seeds.

20. A method comprising:
obtaining a plant kit, the plant kit comprising:
the plant apparatus of claim 1;
a plant carpet comprising a carpet of live flora, wherein a depth of the plant carpet is below a threshold, wherein the plant carpet is absent of soil; and
a coupling medium configured to couple the plant carpet to the exterior surface, wherein the coupling medium comprises a rubber band, a button, or a zipper; and
dressing the carpet around the plant apparatus using the coupling medium, thereby causing roots of the plant carpet to anchor to the exterior surface.

21. A mold for slip casting a plant apparatus, wherein the mold has patterns configured to form a plurality of corresponding indentations in inserted liquid clay of the plant apparatus, wherein the plurality of indentations are suitable for retaining seeds therein, wherein the patterns are configured to form a graduated depth of an exterior surface of the plant apparatus that gradually increases a depth from a top of the exterior surface to a bottom of the exterior surface, wherein the mold is configured to form the plant apparatus comprising:
an internal volume configured for retaining liquid; and
the exterior surface, wherein the exterior surface is made of a porous material enabling liquid to seep out from the internal volume to the indentations of the exterior surface, wherein the exterior surface enables proliferation of plants thereacross.
